(19) United States
(12) Patent Application Publication
(10) Pub. No.: US 2014/0025519 A1
(43) Pub. Date: Jan. 23, 2014

(54) SYSTEM AND METHOD FOR ACQUIRING ELECTRONIC DATA RECORDS

(71) Applicant: David William Thomas, Toronto (CA)

(72) Inventor: David William Thomas, Toronto (CA)

(73) Assignee: OMNEGO INC., Toronto, ON (CA)

(21) Appl. No.: 14/008,396

(22) PCT Filed: Mar. 31, 2011
(86) PCT No.: PCT/CA2011/000332

§ 371 Date: Sep. 27, 2013

(51) Int. Cl. G06Q 20/36; H04L 29/08

(52) U.S. Cl. CPC G06Q 20/36; H04L 29/08
USPC 705/21; 705/41

(57) ABSTRACT

A system and method for acquiring electronic data records is provided. A visual artifact encoded with content for acquiring an electronic data record associated with dynamic content is acquired at a portable electronic device. The visual artifact is processed to determine the content. The electronic data record is retrieved from a remote server via a network connection by processing the content at the portable electronic device.

### FIELD

The present specification relates generally to computing and more specifically relates to a system and method for acquiring electronic data records.

### BACKGROUND

The use of the technical features of electronic devices to replace other technologies is, of course, only increasing. Word processing software has replaced typewriters; packet switched telephony is replacing circuit switched telephony; electronic trading is replacing the traditional stock exchange; banking is also increasingly being handled by electronic transfer of funds in place of paper money or bills of exchange. But there is much more to be done.

Electronic wallet databases are extremely useful in providing a central and computerized storage, retrieval and management environment for electronic coupons and other electronic content such as digital representations of loyalty and gift cards. Electronic computing devices, both portable and desktop, often include contact management applications. However, further advances are possible.

### BRIEF DESCRIPTION OF THE DRAWINGS

FIG. 1 shows a system for management of electronic wallet databases.

FIG. 2 shows a schematic representation of the portable computing device of FIG. 1.

FIG. 3 shows exemplary syntax for a business card uniform resource identifier.

FIG. 4 shows exemplary screen shots from the electronic device of FIG. 1.

FIG. 5 shows exemplary screen shots from the electronic device of FIG. 1.

FIG. 6 shows exemplary screen shots from the electronic device of FIG. 1.

FIG. 7 shows exemplary screen shots from the electronic device of FIG. 1.

FIG. 8 shows exemplary screen shots from the electronic device of FIG. 1.

FIG. 9 shows a flowchart depicting a method of transferring an electronic artifact using the system of FIG. 1.

FIG. 10 shows a flowchart depicting another method of transferring an electronic artefact.

FIG. 11 shows another system for management of electronic wallet databases.

FIG. 12 shows a flowchart depicting a method of transferring electronic artifact content using the system of FIG. 11.

FIG. 13 shows an exemplary screen shot from an electronic device of FIG. 11.

FIG. 14 shows exemplary screen shots from an electronic device of FIG. 11.

FIG. 15 shows an exemplary screen shot from an electronic device of FIG. 11.

FIG. 16 shows a flowchart depicting a method of updating dynamic content using the system of FIG. 11, and where such dynamic content can be utilized by the method of FIG. 12.

FIG. 17 shows an exemplary screen shot from an electronic device of FIG. 11.

FIG. 18 shows an exemplary screen shot from an electronic device of FIG. 11.

FIG. 19 shows an exemplary screen shot from an electronic device of FIG. 11.

FIG. 20 shows a system for management of electronic wallet databases.

FIG. 21 shows a schematic representation of the portable computing device of FIG. 20.

FIG. 22 shows a flowchart depicting a method of acquiring electronic data records using the system of FIG. 20.

FIG. 23 shows a system for management of electronic wallet databases.

FIG. 24 shows printed material including a printed visual artifact encoded with content for acquiring electronic data record associated with dynamic content.

FIG. 25 shows an exemplary screen shot from an electronic device of FIG. 21.

FIG. 26 shows an exemplary screen shot from an electronic device of FIG. 21.

FIG. 27 shows an exemplary screen shot from an electronic device of FIG. 21.

FIG. 28 shows an exemplary screen shot from an electronic device of FIG. 21.

FIG. 29 shows an exemplary screen shot from an electronic device of FIG. 21.

FIG. 30 shows an exemplary screen shot from an electronic device of FIG. 21.

FIG. 31 shows an exemplary screen shot from an electronic device of FIG. 21.

FIG. 32 shows a system for management of electronic wallet databases.

FIG. 33 shows packaging including a printed visual artifact encoded with content for acquiring electronic data record associated with dynamic content.

FIG. 34 shows packaging including a printed barcode for validating the visual artifact of FIG. 33.

FIG. 35 shows a flowchart depicting a method of using electronic data records using the system of FIG. 32.

FIG. 36 shows an exemplary screen shot from an electronic device of FIG. 32.

FIG. 37 shows an exemplary screen shot from an electronic device of FIG. 32.

FIG. 38 shows an exemplary screen shot from an electronic device of FIG. 32.

### DESCRIPTION

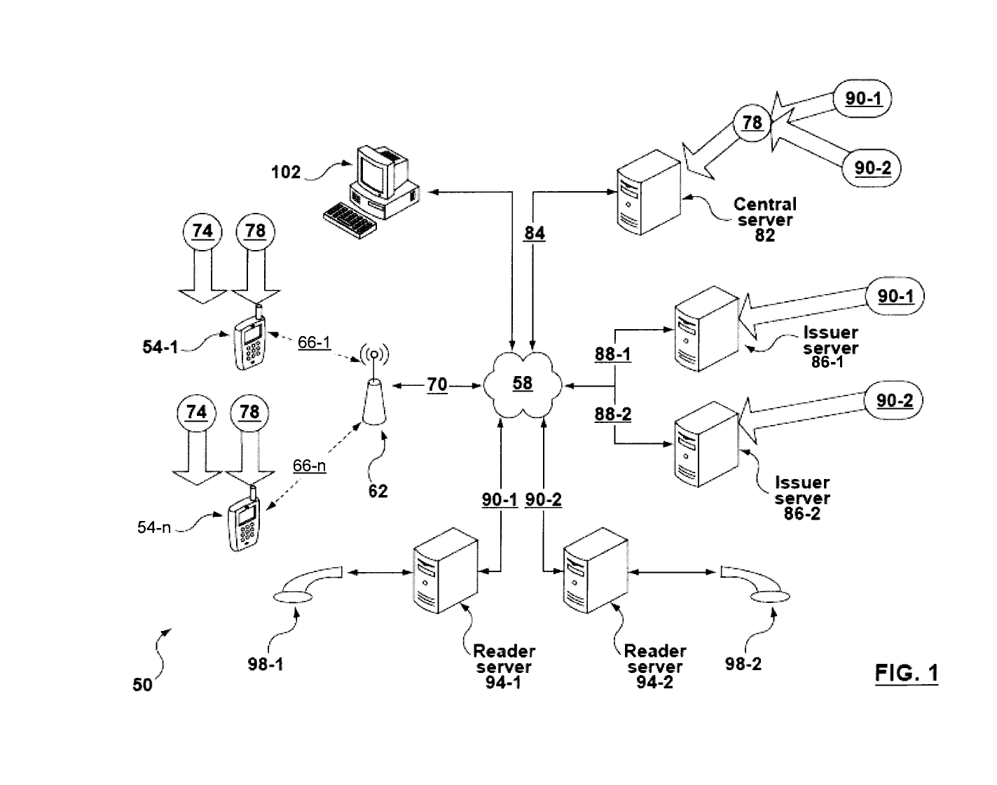

Referring now to FIG. 1, a system for management of electronic wallet databases is indicated generally at 50. In a present embodiment system 50 comprises a plurality of portable computing devices 54-1 . . . 54-n (generically, computing device 54, and collectively, computing devices 54) connected to a network 58 via a wireless base station 62. In turn, wireless base station 62 connects to portable computing device 54 via a wireless link 66 and to network 58 via a backhaul 70.

Network 58 can comprise the Internet, or can comprise any other wide area network such as the public switched telephone network (PSTN), or can comprise combinations of various network topographies.

Base station 62 can be based on one or more architectures including, without limitation, Global System for Mobile communications (GSM), General Packet Radio Service (GPRS), Enhanced Data Rates for GSM Evolution (EDGE), 3G, 4G, Universal Mobile Telecommunications System (UMTS), Institute of Electrical and Electronics Engineers (IEEE) Standard 802.11, IEEE 802.15, Bluetooth. Link 66 therefore corresponds to the architecture of base station 62, and thus portable computing device 54 includes a radio (shown below) so that it is configured to communicate via link 66. Portable computing device 54 can be configured to have multiple radios so that it can communicate over different architectures.

As will be discussed in greater detail below, each portable computing device 54 is configured to maintain its own universal wallet application 74 and a universal wallet data file 78.

System 50 also comprises at least one central server 82 which connects to network 58 via a backhaul link 84. As will be discussed in greater detail below, central server 82 is configured to create, update, delete and otherwise maintain each universal wallet data file 78 respective to each device 54, as will be discussed in greater detail below.

System 50 also comprises a plurality of issuer servers 86-1, 86-o (generically, issuer server 86 and collectively, issuer servers 86), which are connected to network 58 via backhauls 88. As will be discussed in greater detail below, each issuer server 86 is configured to create, update, delete and otherwise maintain individual records 90 which are aggregated into data file 78 by central server 82. Each issuer server 86 is also configured to create, update, delete and otherwise maintain individual records 90 which are aggregated into data file 78 by central server 82.

System 50 also comprises a plurality of reader servers 94-1, 94-p which are connected to network 58 via backhauls 96. Each reader server 94 includes a proximity reader 98 which is an input device that is configured to read output generated by device 54 when device 54 is positioned proximal to one of the readers 98. In a present embodiment, each proximity reader 98 is a barcode scanner, but other types of proximity readers are contemplated as discussed further below.

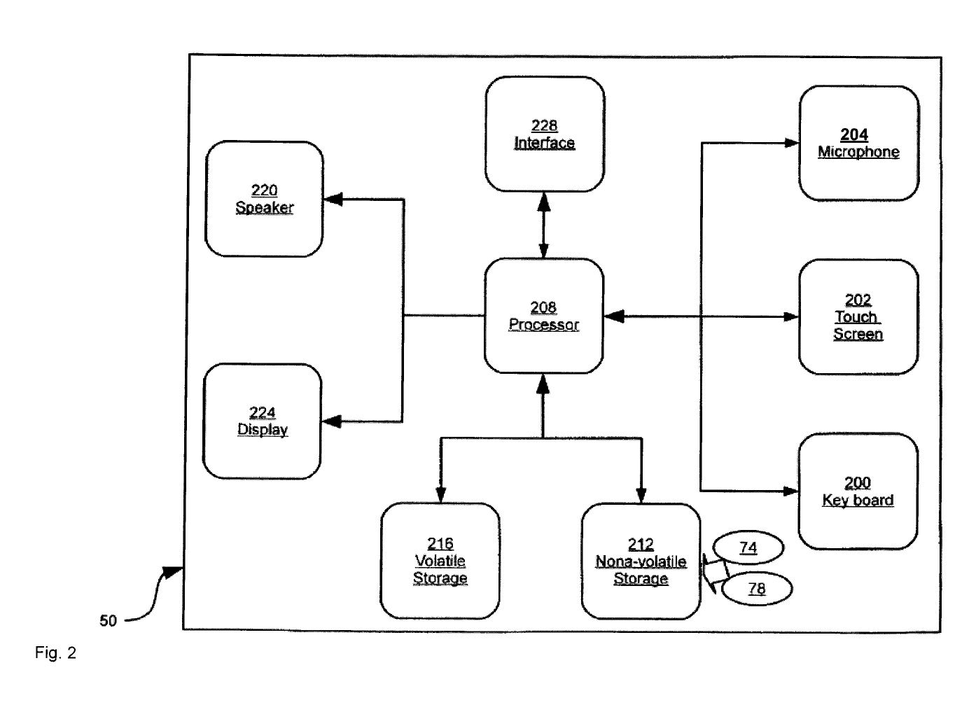

Referring briefly now to FIG. 2, each computing device 54 can be any type of electronic device that can be used in a self-contained manner and to interact with over network 58. Interaction includes displaying of information on computing device 54 as well as to receive input at computing device 54 that can in turn be sent back over network 58. It should be emphasized that the structure in FIG. 2 is purely exemplary, and contemplates a device that can be used for both wireless voice (e.g. telephony) and wireless data (e.g. email, web browsing, text) communications. In a present embodiment, computing device 54 is a mobile electronic device with the combined functionality of a personal digital assistant, a cell phone, and an email paging device. Many well known cellular telephone models, or variants thereof, are suitable for the present embodiment.

Device 54 thus includes a plurality of input devices which in a present embodiment include a keyboard 200, a touch screen 202, and a microphone 204. Touch screen 202 can be implemented as another form of pointing device. Input from keyboard 200, touch screen 202 and microphone 204 is received at processor 208 (which can be implemented as a plurality of processors). Processor 208 is configured to communicate with a non-volatile storage unit 212 (e.g. Erasable Electronic Programmable Read Only Memory (“EEPROM”), Flash Memory) and a volatile storage unit 216 (e.g. random access memory (“RAM”)). Programming instructions that implement the functional teachings of device 54 as described herein are typically maintained, persistently, in non-volatile storage unit 212 and used by processor 208 which makes appropriate utilization of volatile storage 216 during the execution of such programming instructions. Those skilled in the art will now recognize that non-volatile storage unit 212 and volatile storage 216 are examples of computer readable media that can store programming instructions executable on processor 208.

Processor 208 in turn is also configured to control a speaker 220 and a display 224. Processor 208 also connects to a network interface 228, which are implemented in a present embodiment as radios configured to communicate over link 66. In general, it will be understood that interface 228 is configured to correspond with the network architecture that is used to implement link 66. (In other embodiments a plurality of links 66 with different protocols can be employed and thus a plurality of interfaces can be provided to support each link.) It should be understood that in general a wide variety of configurations for device 54 are contemplated.

In a present embodiment, device 54 is also configured to maintain a universal wallet application 74 and a universal wallet data file 78. Universal wallet application 74 is maintained within non-volatile storage 212. Processor 208 is configured to execute universal wallet application 74, such that when universal wallet application 74 is loaded on processor 208, various transistors and other components in processor 208 are arranged in a particular way so that device 54 is, at least temporarily, a uniquely configured piece of hardware that performs the functions of universal wallet application 74. During such time, device 54 is configured to receive input from keyboard 200 relative to universal wallet application 74, and to generate graphical interfaces on display 224. Processor 208 is further configured to access universal wallet data file 78 on behalf of universal wallet application 74, as will be discussed further below.

Referring again to FIG. 1, servers 82, 86 and 94 can be based on any well-known server environment including a module that houses one or more central processing units, volatile memory (e.g. random access memory), persistent memory (e.g. hard disk devices) and network interfaces to allow those servers to communicate over relevant links. For example, servers 82, 86, or 94 or all of them can be a Sun Fire V480 running a UNIX operating system, from Sun Microsystems, Inc. of Palo Alto Calif., and having four central processing units each operating at about nine-hundred megahertz and having about sixteen gigabytes of random access memory. However, it is to be emphasized that this particular server is merely exemplary, and a vast array of other types of computing environments for servers 82, 86, or 94 are contemplated. Those skilled in the art will now recognize that non-volatile storage and volatile storage are examples of computer readable media that can store programming instructions executable on the processors of each server.

In a present embodiment, system 50 utilizes novel custom uniform resource identifiers (“URI”) schemes to pass various forms of data, and/or references to that data, respective to each record 90. Universal wallet application 74 identifies and registers custom URI schemes for each record 90 that conform to the Internet standard described in public RFC 3986—“Uniform Resource Identifier (URI): Generic Syntax”, which may be referenced here: http://labs.apache.org/webarch/org/rfc/rfc3986.html. (“URI Standard”).

Each type of record 90 that wallet application 74 handles is identified by a custom URI scheme. In accordance with the URI Standard, wallet application 74 defines each scheme identifier as well as each constituent component of the URI—the “authority”, “path”, “query”, and “fragment” components. The nature and contents of this latter set of components varies depending upon the specific attributes of the particular type of record 90 that is being described.

Operationally, when one of the URIs associated with a record 90 is encountered during routine user interaction with applications on the mobile device, wallet application 74 is launched and passed the custom URI data associated with a record 90. Such an event triggers the appropriate business process execution within the application 74, based on the specific scheme and data components described in the incoming URI.

A present embodiment comprises a set of custom URIs using the approach outlined above, however further new URIs can be added to this list over time to support other types of records 90. Table I provides such an exemplary list of custom URI schemes:

TABLE I

| URI Scheme Definition | Type of Record 90 |
|---|---|
| “Bizcard://” | A virtual business card or contact data |
| “VanityCard://” | A user-created representation of a plastic or |
| | paper ID card |
| “LoyaltyCard://” | A store-issued customer card |
| “IDCard://” | A card used mainly for identification purposes, |
| | such as a student ID |
| “SVCard://” | A representation of a stored value card |
| | (i.e. gift or prepaid card) |
| “RetailCoupon://” | A coupon issued by a retailer or store |
| “MfgCoupon://” | A coupon issued by a product manufacturer |
| “EventBadge://” | A credential issued to permit access to an event |
| “Receipt://” | A digital representation of a sale receipt |
| “EventTicket://” | A ticket to a short-duration event such as a |
| | concert or game |
| “SubscriberPass://” | A recurring, longer duration pass such |
| | as for public transit systems |
| “Calendar://” | A virtual calendar appointment or event |

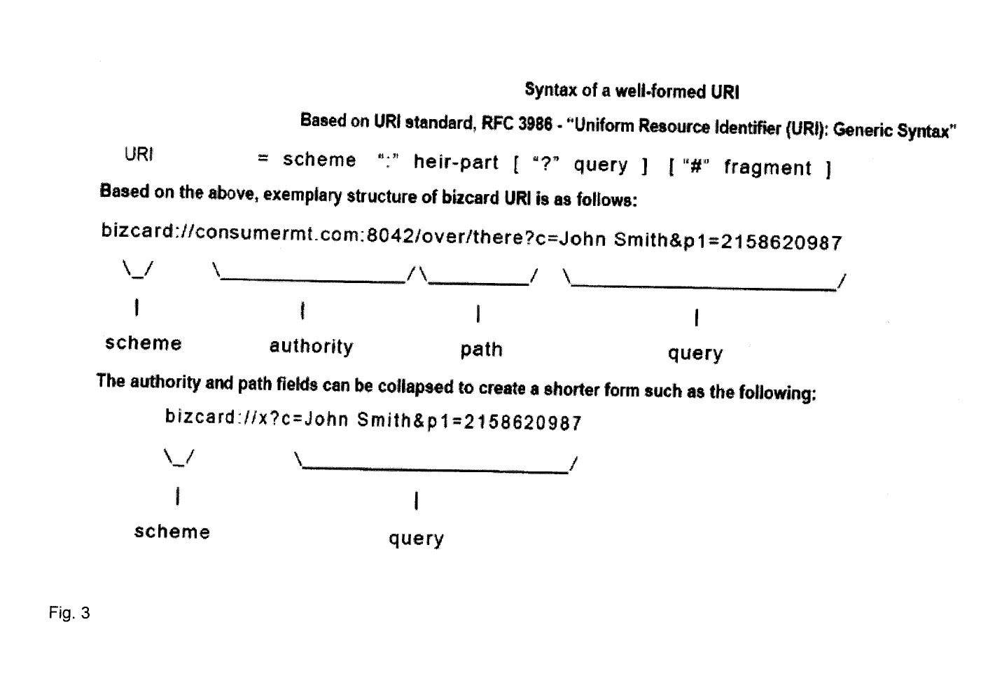

FIG. 3 shows an exemplary structure for the “Bizcard://” URI Scheme Definition. As the example in FIG. 3 shows, the various fields that make up the business card contents are encoded within the query string of the URI. Note that several of the fields are optional and can be left out if desired. In addition, more fields may be added to the definition in the future as needs dictate. Table II summarizes exemplary field identifiers that can be supported for the “Bizcard://” URI Scheme.

TABLE II
Exemplary Bizcard URI Scheme Fields

| Field | Prefix |
|---|---|
| Full name or composite name | c= |
| First name | f= |
| Last name | l= |
| Organization | o= |
| Title | j= |
| Email address | e= |
| Street address 1 | r1= |
| Street address 2 | r2= |
| City | t= |
| State/province | s= |
| Postal code | z= |
| County | y= |
| URL | u= |
| Phone 1 | p1= |
| Phone 2 | p2= |
| Note | n= |

Using Table II, an exemplary business card URI can appear as follows (ignoring the carriage returns resulting of page width restrictions):

“bizcard://v?c=John R. Smith&f=John&1=Smith&o=Tyco Toys Inc.&j=President and CEO&e=john.smith@tyco.com&r1=123 Main St.&r2=Suite 101&t=Newtown&s=PA&z=18935&y=USA&u=www.tyco.com&p1=2158452340&p2=2673439087&n=We are tops in toys”. Those skilled in the art will now appreciate that the other URI schemes from Table I can be constructed in a like fashion.

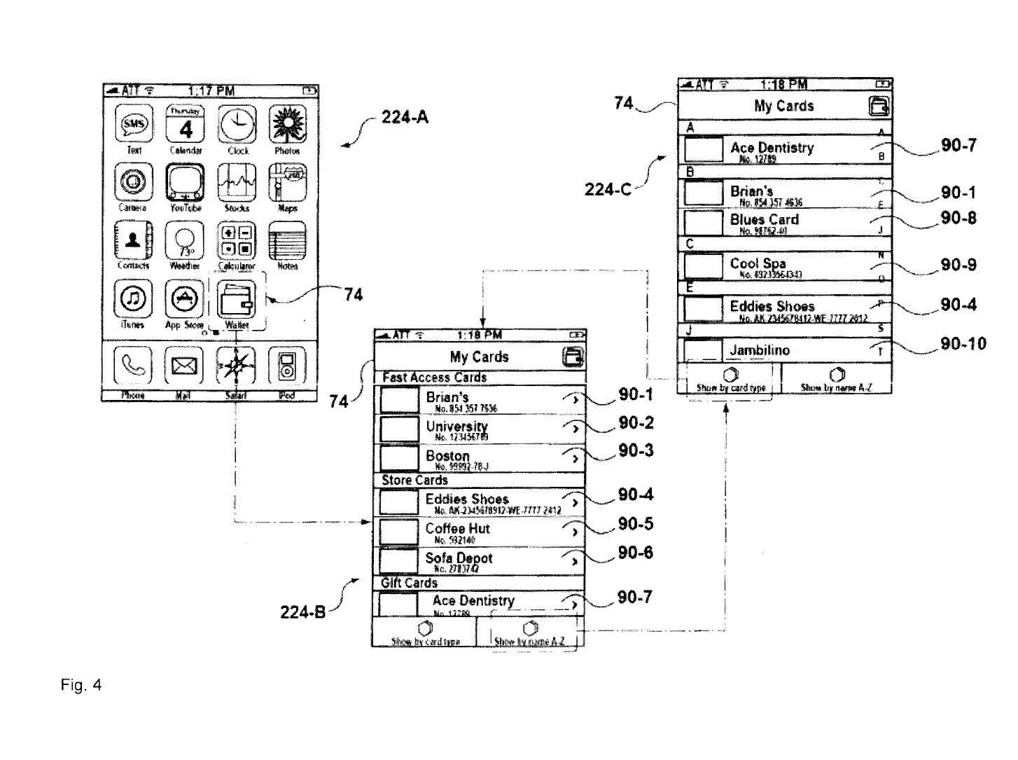

Referring now to FIG. 4, exemplary screen shots from display 224 of device 54 are provided showing certain exemplary invocation and performance of application 74. The first screen shot, marked as display 224-A shows the main menu of a plurality of applications which can be executed on device 54, including wallet application 54. Upon depressing touchscreen 202 in the area of display 224-A corresponding to the icon for application 74, application 74 will be loaded onto processor 208 and executed thereby. Upon loading and execution of application 74 onto processor 208, the screen shot marked as display 224-B on FIG. 4 shows a screen labeled “My Cards” which includes a plurality of virtual cards of various types, each of those cards representing a different data record 90. On display 224-B, cards are sorted by type. Depressing touchscreen 202 in the area of display 224-B indicated will invoke display 224-C, which sorts the same cards alphabetically. Note that display 224-B and display 224-C contemplate ten different cards corresponding to ten different data records 90. It is to be understood that any number of different cards and corresponding data records 90 can be maintained in device 54 subject to resource (i.e. memory and processor) constraints of device 54. Note that cards corresponding to data records 90 on display 224-B and display 224-C thus reflect the contents of universal wallet data file 78. Also note that while ten different cards are shown in display 224-B and display 224-C, only two card issuer data servers 86 are shown in FIG. 1, but it should be understood that more card issuer data servers 86 can be provided, one for each card corresponding to each data record 90. Device 54 is configured to return from display 224-C to display 224-B when the area of display 224-C that is indicated is depressed.

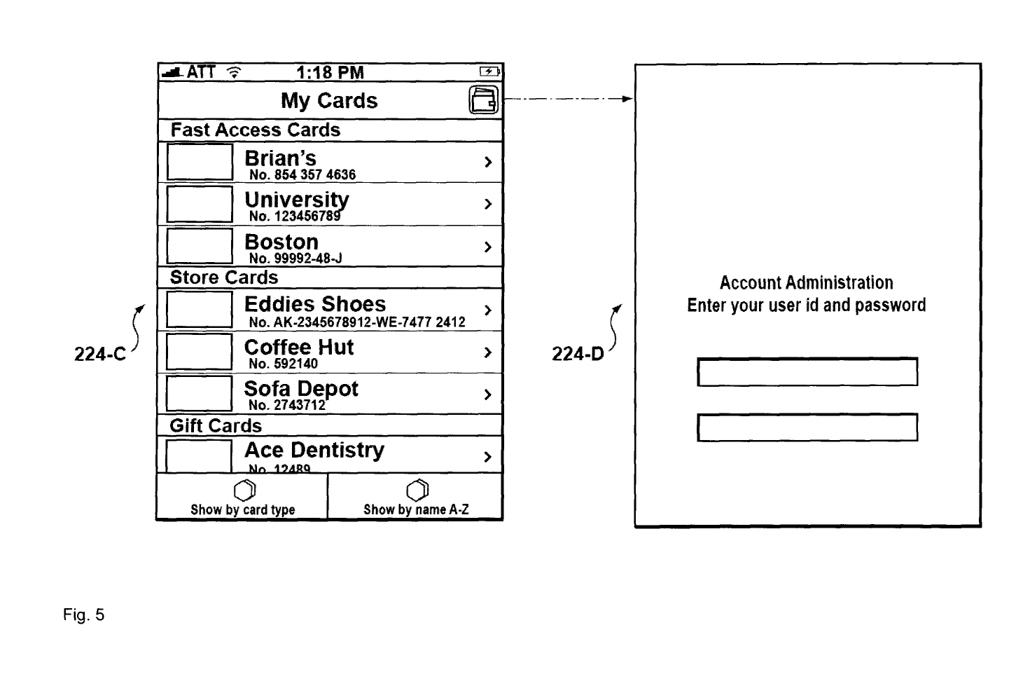

Referring now to FIG. 5, depressing touchscreen 202 in the indicated area of display 224-C will invoke display 224-D. Display 224-D shows a log-in screen for an administration tool that is hosted by central server 82 which can be used to administer the account on central server 82 that corresponds to device 54 and data file 78. Display 224-D and such account administration can also be invoked from the web-browser computer 102. Such administration can include updating identity information, address information, data records 90 and other administrative operations.

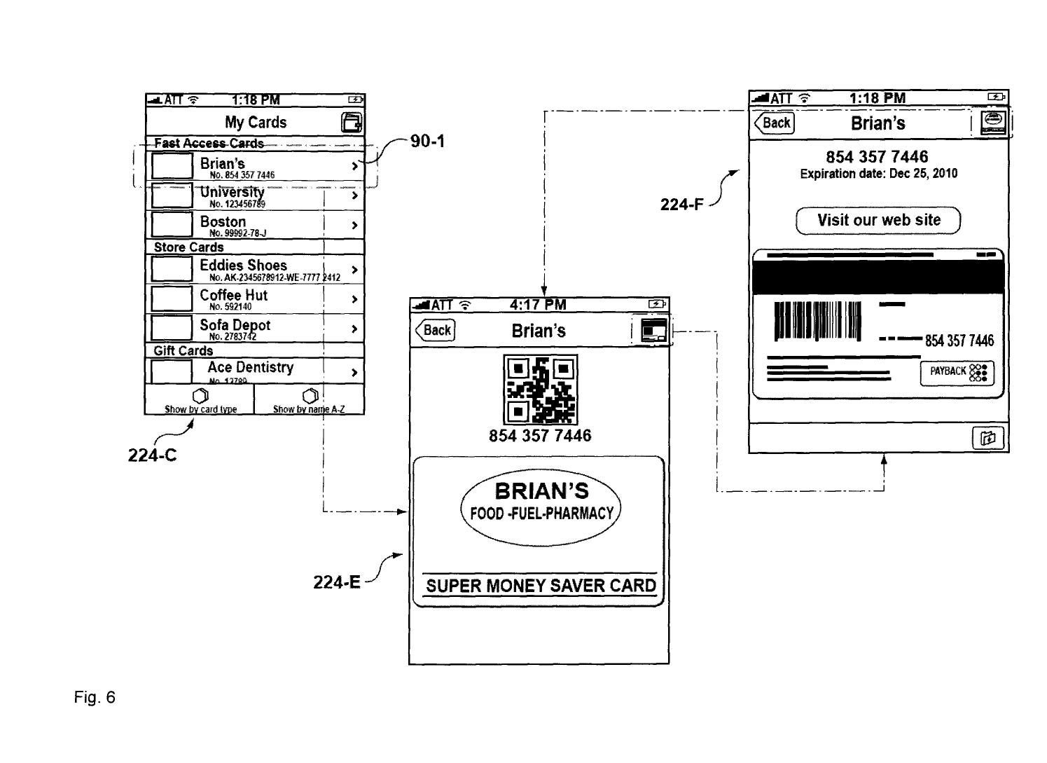

Referring now to FIG. 6, depressing touchscreen 202 in the indicated area of display 224-C will invoke display 224-E. Depressing touchscreen 202 in the indicated area of display 224-E will invoke display 224-F. Display 224-E and display 224-F show the contents of data record 90-1 corresponding to a first card. Data record 90-1 is of the URI Scheme Definition “LoyaltyCard://” In the present embodiment display 224-E shows the front of a virtual loyalty card issued by a pharmacy, whereas display 224-F shows the back of the same virtual loyalty card. Note that in the present embodiment the front and back of the virtual loyalty card is substantially an accurate facsimile of an actual loyalty card that is typically carried in a physical wallet.

Display 224-E, in addition to showing the front of the virtual loyalty card, also includes a machine readable indicia that can be read by reader 98.

Display 224-F, as part of the back of the virtual loyalty card, includes a facsimile of a bar code that would actually appear on the back of the virtual loyalty card, such a bar code being an additional machine readable indicia that can be read by reader 98. In addition to the back of the virtual loyalty card, display 224-F also includes a reproduction of the loyalty card number, the expiry date and a selectable area of touchscreen 202 entitled “Visit our web site” that can be selected to cause display 224 to shows a web-site hosted on the issuer server 86-1 corresponding to data record 90-1, such a web-site allowing administration of an individual account associated with data record 90-1.

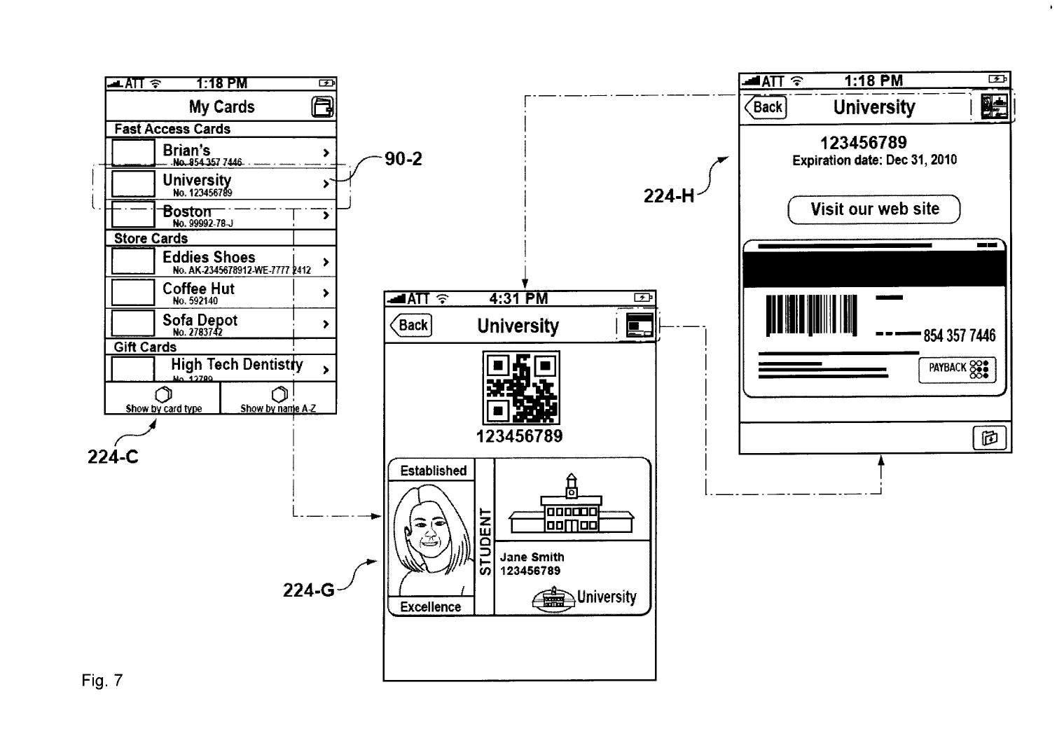

Referring now to FIG. 7, depressing touchscreen 202 in the indicated area of display 224-C will invoke display 224-G (Note that this area in FIG. 7 is slightly different than the corresponding area in FIG. 5. This is for example purposes only—either area can be selected.) Depressing touchscreen 202 in the indicated area of display 224-G will invoke display 224-H. Display 224-G and display 224-H show the contents of data record 90-o corresponding to a second card. Data record 90-o is of the URI Scheme Definition “IDCard://” In the present embodiment display 224-G shows the front of an identity card issued by a university, whereas display 224-H shows the back of the same university identity card. Note that in the present embodiment the front and back of the university identity card is substantially an accurate facsimile of a university identity card that is typically carried in a physical wallet.

Display 224-G, in addition to showing the front of the identity card, also includes a machine readable indicia that can be read by reader 98.

Display 224-H, as part of the back of the identity card, includes a facsimile of a bar code that would actually appear on the back of the identity card, such a bar code being an additional machine readable indicia that can be read by reader 98. In addition to the back of the identity card, display 224-H also includes a reproduction of the identity card number, the expiry date and a selectable area of touchscreen 202 entitled “Visit our web site” that can be selected to cause display 224 to shows a web-site hosted on the issuer server 86-o corresponding to data record 90-o, such a web-site allowing administration of an individual account associated with data record 90-o.

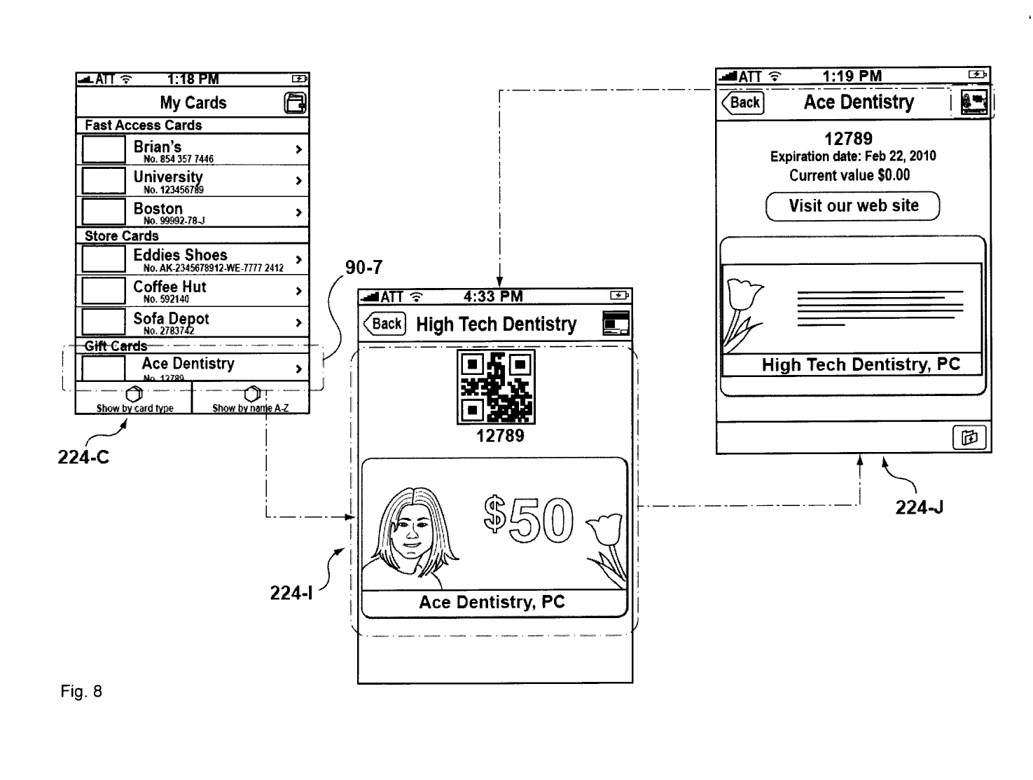

Referring now to FIG. 8, depressing touchscreen 202 in the indicated area of display 224-C will invoke display 224-I. Depressing touchscreen 202 in the indicated area of display 224-I will invoke display 224-J. Display 224-J and display 224-I show the contents of data record 90-7 corresponding to another card. Data record 90-7 is of the URI Scheme Definition “SVCard://” In the present embodiment display 224-I shows the front of a gift card issued by a dentist, whereas display 224-J shows the back of the same gift card. Note that in the present embodiment the front and back of the gift card is substantially an accurate facsimile of a gift card that is typically carried in a physical wallet.

Display 224-I, in addition to showing the front of the gift card, also includes a machine readable indicia that can be read by reader 98.

Display 224-J, as part of the back of the gift card, includes a legal disclaimers that actually appear on the back of the virtual loyalty card. In addition to the back of the gift card, display 224-J also includes a reproduction of the gift card number, the expiry date and a selectable area of touchscreen 202 entitled “Visit our web site” that can be selected to cause display 224 to shows a web-site hosted on the issuer server 86 corresponding to data record 90-7, such a web-site allowing administration of an individual account associated with data record 90-7. Display 224-J also shows the current remaining value on the gift card, shown as “Zero” on display 224-J.

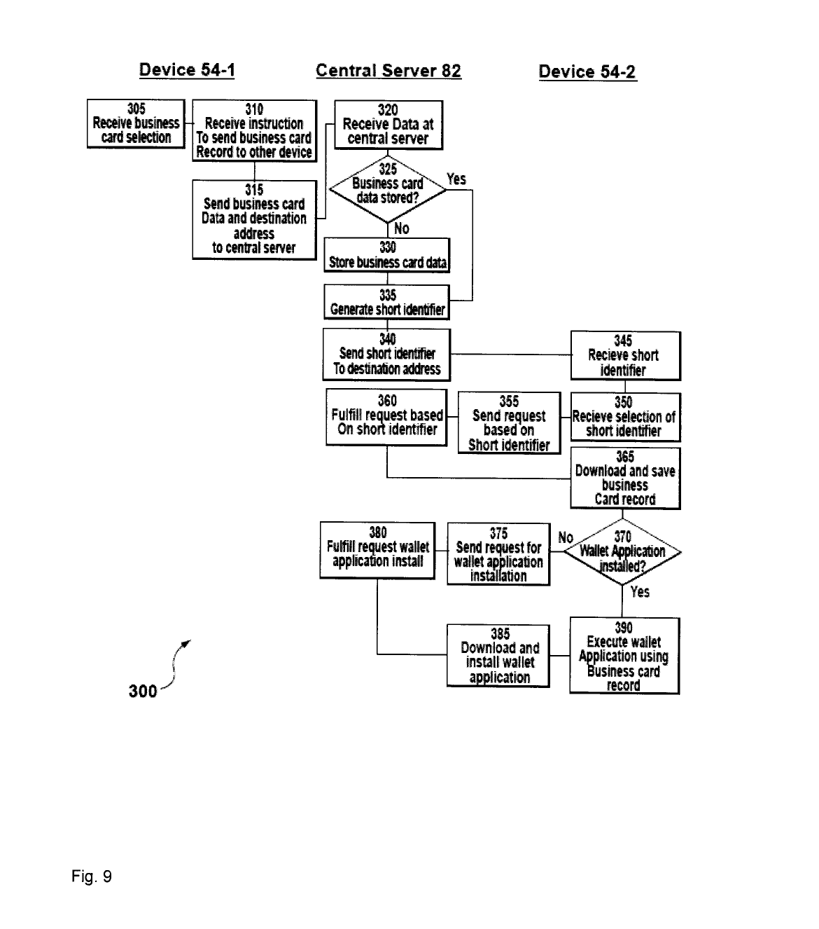

Referring now to FIG. 9, a method for transferring a business card record from one portable computing device to another portable computing device is depicting in the form of a flow-chart and indicated generally at 300. Method 300 can be explained using system 50, and in the context of device 54-1, central server 82 and device 54-2 but it will be understood that method 300 can be implemented on variations of system 50. In the following description, it will be assumed that device 54-1 has a business card data record 90 stored thereon, and that business card data record 90 is to be transferred to device 54-2.

At block 305, a selection of a business card record is received. In the present example, block 305 is performed by device 54-1. Block 305 can be effected in much the same manner as gift card record 90-7 was selected accord to FIG. 8, or the other examples in FIGS. 6 and 7. Such a selection is for a business card record conforming with a business card URI scheme, such as the scheme shown in FIG. 3, as stored in data file 78 of device 54-1.

At block 310, an instruction is received to send the selected business card record to another device. Block 310 can be effected by receipt of an instruction received via a touch screen 202, which indicates that the record selected at block 305 is to be sent to another device, the address of such a destination device being also received at block 310.

The destination device address can be received in any form, but a typical example is the Mobile Subscriber Integrated Services Digital Network (ISDN) Number (MSISDN) or the actual telephone number associated with the destination device. A menu item can be provided as part of wallet application 74 that is generated on display 224 can be used to simplify the ease of provision of the instruction associated with block 310. In the present example, the instruction at block 310 indicates that the record is to be sent to device 54-2.

At block 315, the business card record selected at block 310 is sent to the central server. Block 315 is effected by device 54-1 transmitting business card record 90 to central server 82 via the infrastructure in system 50 of FIG. 1, or a suitable variation thereof.

At block 320, the business card record sent at block 315 is received at server 82. At block 325, a determination is made as to whether the business card record received at block 320 is already stored at central server 82 in the copy of data file 78 that is maintained at central server 82. If “no”, then method 300 advances to block 330 and the business card record received at block 320 is stored in data file 78. If the determination at block 325 is “yes” then method 300 advances to directly block 335.

At block 335, a short identifier is generated. Such a short identifier is uniquely associated with the business card record received at block 320 and stored in the copy of data file 78 that is local to server 82. The short identifier can be in the form of a hyper text transfer protocol (HTTP) URI, of the exemplary form, “http:/centralserver82.com/businesscardrecord90”. In the foregoing example, “centralserver82.com” represents the uniform resource locator (URL) for central server 82 on network 58, while “businesscardrecord90” identifies the business card record received at block 320 and stored at the copy of data file 78 that is locally maintained on central server 82.

At block 340, the short identifier generated at block 335 is sent to the destination device that was originally identified at block 310, such a destination address having been transmitted to server 82 at block 315. In a present embodiment, the short identifier is sent via short message service (SMS). In this manner, central server 82 need not have any understanding of the architecture or computing environment of the destination device 54-2. Thus, the composed SMS can include the following exemplary text: “You are being sent an electronic business card record. To retrieve this record, please select the following link from your mobile device browser: http:/centralserver82.com/businesscardrecord90”. The SMS is sent via the infrastructure in FIG. 1, or a suitable variation thereof.

At block 345, the short identifier is received at the destination device 54-2. In the present embodiment, the SMS described at block 340 is received via an SMS application local to device 54-2.

At block 350, a selection of the short identifier is received. Block 350 typically comprises execution of the SMS application local to device 54-2 and generation of the SMS on display 224 of device 54-2. Block 350 further comprises the selection of the short identifier (i.e. http:/centralserver82.com/businesscardrecord90) via input entered through touch screen 202 or other pointing or input device on device 54-2, so as to invoke a browser application local to device 54-2 on the processor 208 of device 54-2. (In the event such a selection is not made, then method 300 terminates).

At block 355, a request is sent to the central server based on the short identifier selected at block 350. In the present example, the request is sent using the browser application native to device 54-2 via the infrastructure of FIG. 1 or a suitable variation.

At block 360, the request from block 355 is received at server 82 and fulfilled. In the present example, block 360 is effected by server 82 accessing the local copy of data file 78 to retrieve the business card record 90 received at block 320 and to send that business card record 90 to device 54-2. At block 365 the business card record sent at block 360 is downloaded and saved in a local copy of data file 78 at device 54-2. In the present example, the business card record 90 is sent in the form described above, namely in the form as follows:

“bizcard://v?c=John R. Smith&f=John&l=Smith&o=Tyco Toys Inc.&j= President
and CEO&e=john.smith@tyco.com&r1=123 Main St.&r2=Suite 101&t=
Newtown&s=PA&z=18935&y=USA&u=www.tyco.com&p1=2158452340&p2=267343
9087&n=We are tops in toys”.

At block 370 a determination is made as to whether the wallet application is installed. If the determination is “no” then at block 375 a request is sent to download and install the wallet application 74 locally on device 54-2. At block 380 the request from block 375 is received and fulfilled at server 82 by sending a file that can be used to install application 74 on device 54-2. At block 385 the wallet application is downloaded onto device 54-2 and installed locally thereon. At block 390 (which can be reached directly from block 370 if a “yes” determination is made at block 370), the wallet application is executed using the business card record downloaded at block 365. At this point device 54-2 is able to generate screens in the type shown in FIGS. 4-8.

(As variation of method 300, and an alternative to an automatic determination at block 370, method 300 can be varied to eliminate block 370 such that it is presumed that wallet application is already installed, or providing an alternative flow so that user input can be received requesting download and installation of the wallet application). Graphical images associated with the downloaded card can be downloaded separately, such that when input is received to access a particular card in the wallet application, then can be web service call is made dynamically (for example to a free Google web service) to get the generated image associated with the accessed business card.

It should be understood that each device 54 can be manufactured by different entities and can have varying infrastructures, in which case the exact structure of application 74 and file 78 for each device 54 can vary according to those infrastructures. Therefore, it will be noted that the fulfilling of the download request at block 380 can include sending the version of application 74 that is configured specifically to the unique infrastructure of the device 54 requesting download and installation of that application.

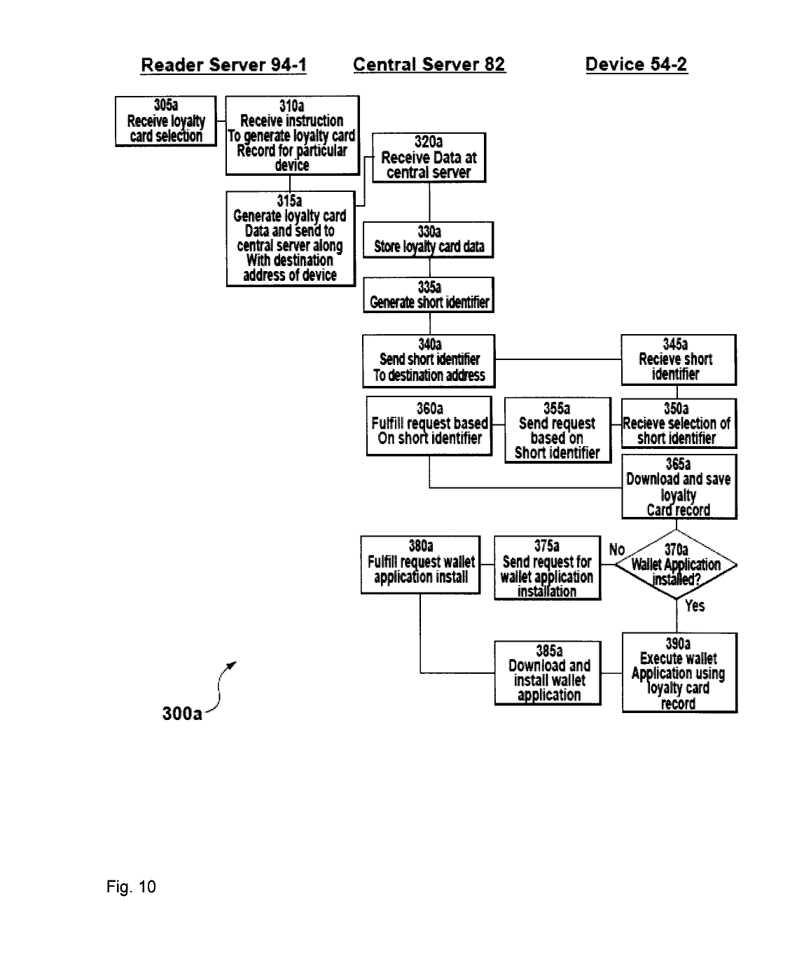

Those skilled in the art will now recognize that method 300 can be varied in order to send other types of data records 90 to devices 54. FIG. 10 shows such an example of a variation of method 300, in the form of method 300a. In method 300a, like blocks to method 300 are shown with the same reference, except followed by the suffix “a”. Of note is that method 300a pertains to the generation and sending of a loyalty card data record 90 to a device 54, and thus method 300a arises in the context of generation of a loyalty card. In method 300a, it is assumed that reader server 94-1 is associated with a point of sale of an enterprise that utilizes loyalty cards, and that device 54-2 is proximal to that reader server 94-1 but that device 54-2 has no loyalty card record associated with that enterprise, but that a request is being made to generate such a loyalty card record 90 so that such a loyalty card record can be generated and stored locally on device 54-2. It is also assumed that issuer server 86-1 is associated with the enterprise and is configured to generate loyalty card records 90 respective to that enterprise.

In the specific example of FIG. 10, method 300a, blocks 305a and 310a involve receiving a request to generate loyalty card record 90-1 at reader server 94-1 which is sent to issuer server 86-1. Block 305a can include all particulars that are needed to generate the loyalty card record, including destination MSISDN, a name and/or address to be included in the loyalty card record and the like.

At block 315a, issuer server 86-1 receives the request generated at block 310a and in response generates loyalty card record 90-1 and forwards that data to central server 82a. The generation of the loyalty card record 90-1 can include incorporation of the particulars received at block 305a, as well as a specific loyalty card number for that record 90.

At block 315a, the loyalty card data and the destination MSISDN is sent to the central server 82, where it is received at block 320a. At block 330a the loyalty card data is stored in the central server local version of data file 78. The remainder of method 300a is effected in substantially the same manner as the corresponding blocks in method 300. Advantageously, the entire performance of method 300a can be performed within minutes, or even less than a minute, such that when block 390a is reached the loyalty card record 90 can be generated on display 224, in much the same manner as shown in FIG. 6, such that the reader 98-1 can be used to read the machine readable indicia from record 90 as discussed above.

Those skilled in the art will now appreciate that other URI scheme definitions from Table I can also be deployed using suitable modifications of method 300 or method 300a.

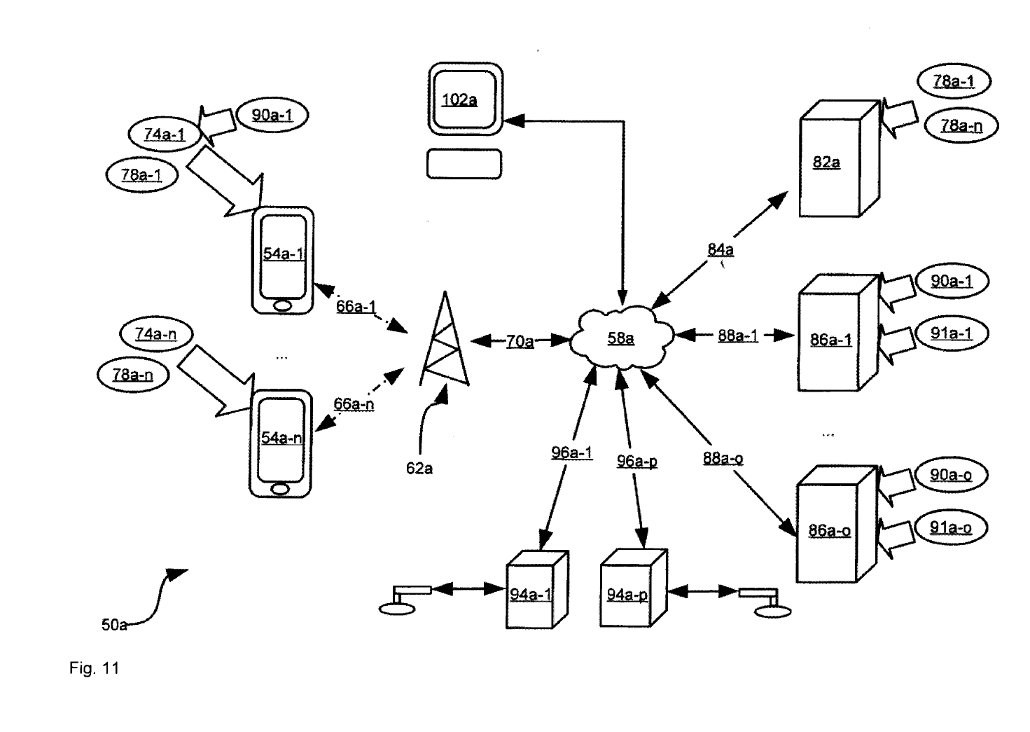

Referring now to FIG. 11, according to another embodiment a system for management of electronic wallet databases is indicated generally at 50a. System 50a is a variation on system 50, and accordingly, like elements bear like references, except the suffix “a” is included for elements in system 50a. Of note is that in system 50a, servers 86a further comprise at least one dynamic content file 91a. Dynamic content file 91a, in general terms, comprises data that is dynamically updated in relation to a corresponding data record 90a. As will be explained further below, a display can be generated on a given device 54a that comprises both a given record 90a maintained with a local data file 78a, as well as a corresponding dynamic content file 91a.

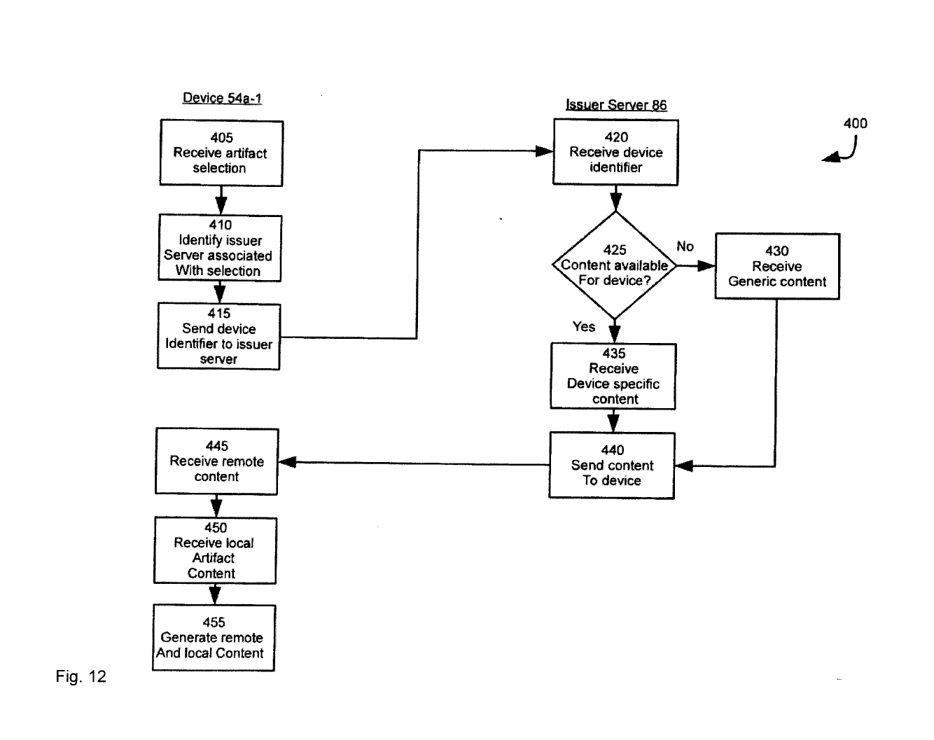

Referring now to FIG. 12, a method for management of electronic wallet databases is depicted in the form of a flow-chart and indicated generally at 400. Method 400 can be explained using system 50a, and in the context of device 54a-1, server 82a and server 86a, but it will be understood that method 400 can be implemented on variations of system 50a. In the following description, it will be assumed that device 54a-1 has an airline reward miles card data record 90a-1 stored thereon which was transferred thereto according to one of the earlier described teachings, or a variation thereon. It will be further assumed that airline reward miles card data record 90a-1 was issued by server 86a-1.

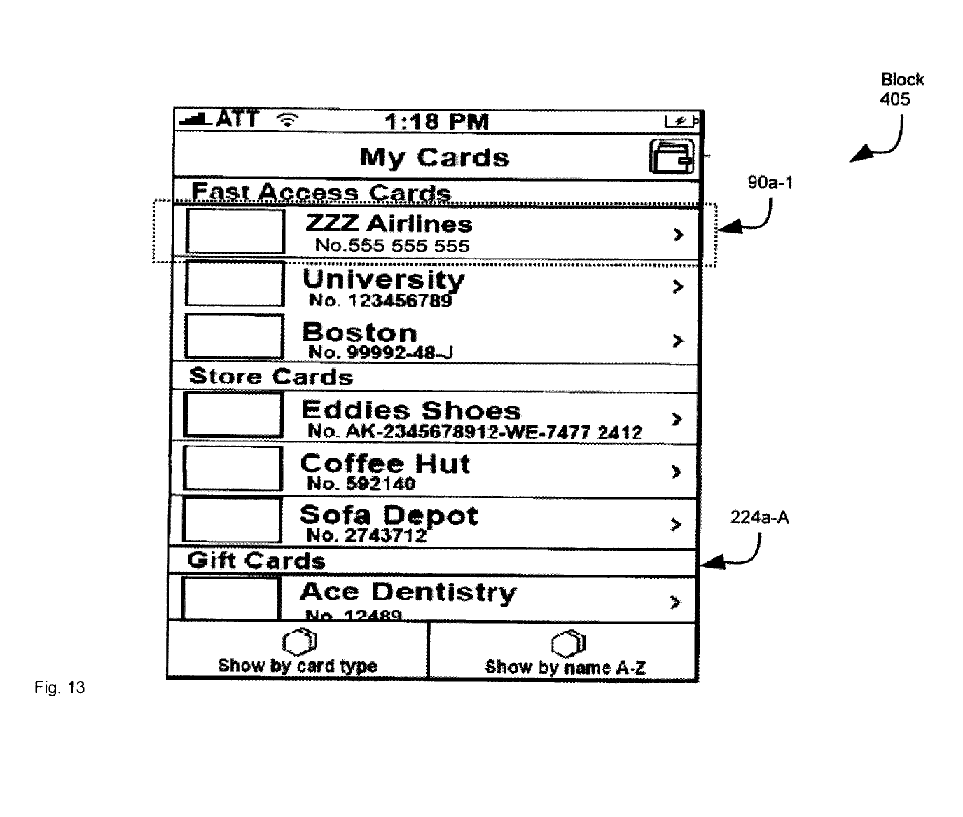

Beginning at block 405, an artifact selection is received. For purposes of explaining the block 405, reference is made to FIG. 13, which shows exemplary selection of record 90a-1 from an exemplary display 224a-A. Note that record 90a-1 corresponds to an airline reward miles card entitled “ZZZ Airlines” with the account number “555 555 555”. Again, as previously discussed, record 90a-1 was originally issued by issuer server 86a-1, which is assumed to be operated by an airline named “ZZZ Airlines”, and which has issued a reward miles card for storage on a given device 54a.

Referring again to FIG. 12, block 410 comprises identifying an issuer server associated with the selection received at block 405. In the present example, record 90a-1 is configured to maintain a network address (such as an Internet Protocol address) or other identifier of server 86a-1 which can be used to address server 86a-1 via network 58a. Accordingly, as part of block 410, and in response to the selection made at block 405, an examination of record 90a-1 is made to ascertain the address associated with record 90a-1.

Block 415 comprises sending the device identifier, or other account identifier associated with record 90a-1, to the issuer server identified at block 415. The device identifier or account identifier can be based on, for example, the account number “555 555 555” that is associated with record 90a-1. Other device identifiers or account identifiers will now occur to those skilled in the art, including, by way of non-limiting example, the phone number associated with device 54a-1, or International Mobile Subscriber Identity (IMSI) associated with device 54a-1. It is also contemplated that multiple identifiers may be sent at block 415 in order to assist in authentication of a valid request.

Block 420 comprises receiving the device identifier at the issuer server identified at block 410. At this point it will now be apparent that block 420 (and following steps) are performed by whichever issuer server 86a that is identified at block 410. Continuing with the specific example discussed above, issuer server 86a-1 will receive the account number “555 555 555” at block 420. Implicit with receipt of this account number is a recognition at server 86a-1 that an artifact selection corresponding to record 90a-1 was made at block 405, and that an instruction has been received at processor 208 to control display 224 to generate the contents of record 90a-1.

Block 425 comprises determining if content is available for the device corresponding to the device identifier received at block 420. A “no” determination leads to block 430, at which point generic content is retrieved. Generic content may comprise no data whatsoever, or may comprise general messages that can be addressed to any holder of (in the specific example being discussed) an airline reward miles card issued by server 86a-1. Such general messages, in the context of the airline, can include, for example, messages identifying upcoming seat sales for the airline.

In contrast, a “yes” determination at block 425 leads to block 435. Block 435 comprises receiving device specific content, which may be content targeted for a particular device. Device specific content comprises messages that are specifically associated with the device or account identifier received at block 420. As a non-limiting example, an accumulated “air miles” balance associated with account number “555 555 555” may be retrieved from storage on, or accessible to, server 86a-1. In particular, such an accumulated “air miles” balance may be stored in dynamic content file 91a.

Assume, for purposes of explanation, that a balance of “27000 miles” is accumulated in association with account number “555 555 555” and is stored within dynamic content file 91a-1.

Block 440 comprises sending content that was received either at block 435, or at block 430, to the device. More specifically, the content is sent to the device associated with the device identifier received at block 420. In the specific example being discussed, the dynamic content from block 435 is sent at block 440, such dynamic content comprising “Your current balance is 27000 miles”.

Block 445 comprises receiving remote artifact content. Block 445 thus comprises receiving the content 91a-1 (e.g. “Your current balance is 27000 miles”.) that was sent at block 440 locally at device 54a-1.

Block 450 comprises receiving local artifact content. Block 450 thus comprises receiving the contents of record 90a-1 as locally stored on device 54a-1.

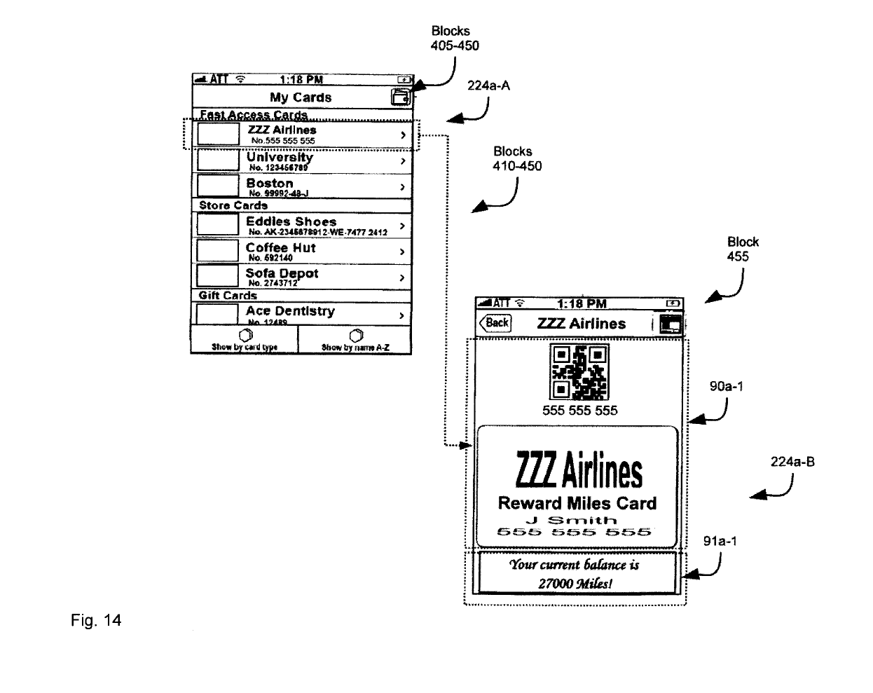

Block 455 comprises controlling the display of the device to generate the content received at block 445 and block 450. Block 455 is represented, in a non-limiting exemplary manner, in FIG. 14, which shows exemplary generation of record 90a-1 and content 91a-1 on display 224a-B, under the control of processor 208. Note that display 224a-B shows record 90a-1, and also shows content 91a-1. It should be understood that the layout of display 224a-B as shown in FIG. 14 is purely exemplary, and that other layouts are contemplated. For example, content 91a-1 may be shown between different portions of record 90a-1, such as between the bar code representation of the wallet artifact, and the graphic representation of the wallet artifact.

It should be noted that method 400 can be modified so that the portion of display 224a-B reserved for content 91a-1 can be left blank in the event that a period of time between block 415 and block 445 is exceeded, without actually receiving the remote content at block 445. Furthermore, when link 66a-1 is “off”, so that there is no communication between device 54a-1 and base station 62a, then method 400 can be modified to omit blocks 415 through 445.

It should also be understood that the blocks in method 400 need not be performed in the sequence shown. For example, block 450 can be performed at almost any time after block 405 and prior to block 455.

As another variation, one or more of blocks 420, 425, 430, 435 and 440 can be performed by central server 82 instead of issuer server 86.

As another variation, one or more communications in method 400 between a given server and a given device may be conducted over a secure, encrypted channel to preserve confidentiality and privacy.

As another variation, method 400 can be modified to reflect a “push” paradigm. Such a push paradigm can be effected by, for example, making block 420-440 non-contingent on performance of blocks 405-415.

Any or all variations contemplated herein may be combined with each other.

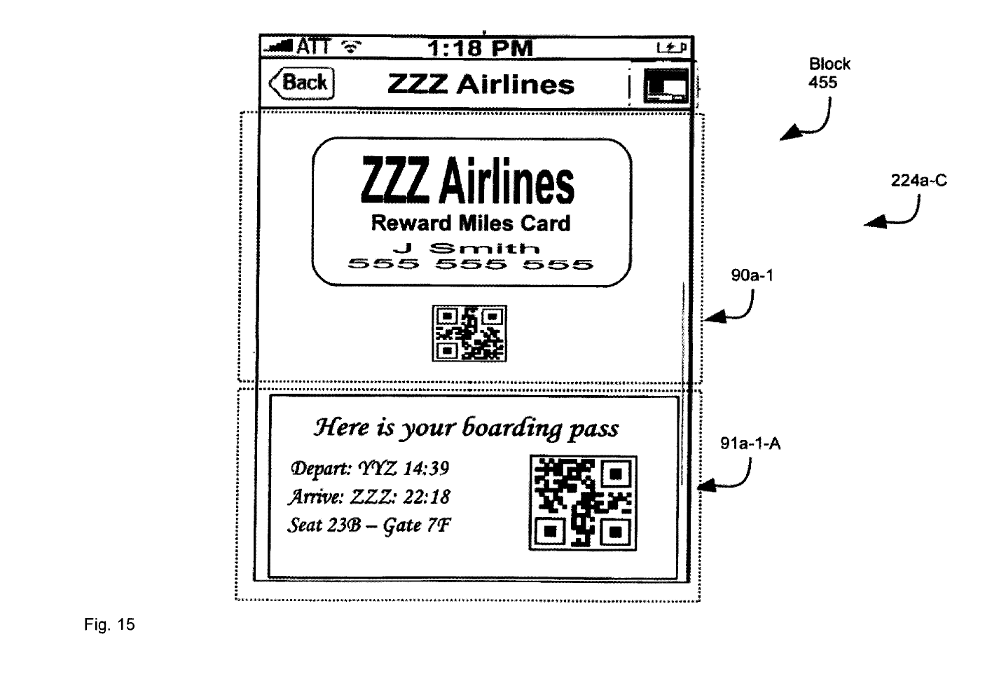

It should also be understood that content 91a-1 can comprise additional content, or different content, than in the specific example shown in FIG. 14. FIG. 15 shows such an example, which shows exemplary performance of block 455, except that content 91a-1 is replaced with content 91a-1-A. Content 91a-1-A, which can be retrieved from server 86a-1, is an electronic boarding pass corresponding to an upcoming flight that is associated with device 54a-1, as identified by account “555 555 555”.

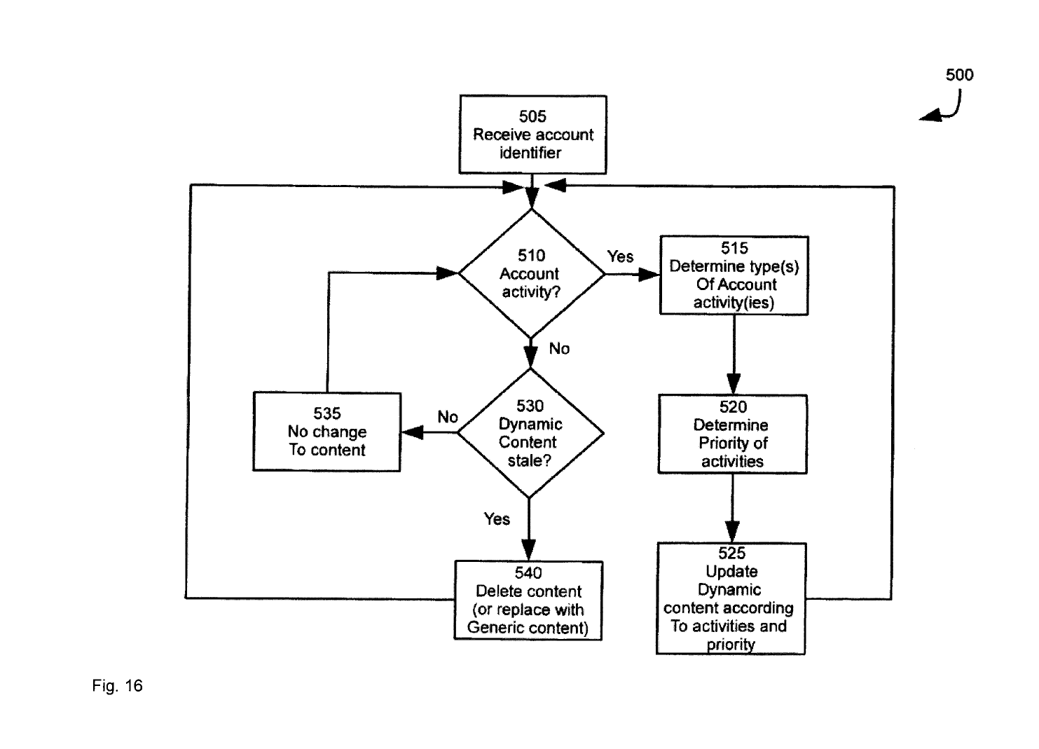

Indeed, the means by which dynamic content 91a is updated is not particularly limited. However, it is, in fact, contemplated that during subsequent cyclings of method 400, the content sent at block 440 will change, even though the local artifact content from block 450 may not change. Referring now to FIG. 16, a non-limiting example of a method for updating dynamic content is depicted in the form of a flow-chart and indicated generally at 500. Method 500 can be performed by issuer server 86a, or, in a modified version of system 50a, central server 82a or elsewhere.

Block 505 comprises receiving an account identifier or other device identifier. The account or device identifier can be any identifier that uniquely identifies a given artifact or record 90a. For example, in the example shown in FIG. 14, the identifier was the account number “555 555 555”. Generally, the identifier at block 505 will be the same as, or map to, the identifier referenced at block 420.

Block 510 comprises determining if there has been any account activity. The means by which the determination is made at block 510 is not particularly limited. In general terms, any change to any database that has records associated with the account identifier from block 505 can result in a “yes” determination at block 510, and in contrast, where no changes have occurred in any databases that have records associated with the account identifier from block 505 can result in a “no” determination at block 510. As a specific, non-limiting example, any scanning of a bar code within a record 90a by a reader 98a and processing of that bar code can constitute activity that results in a “yes” determination. As another example, an electronic purchase or other electronic transaction that is tracked in association with the account identifier at block 505 can result in a “yes” determination at block 510.

In the specific example given above, an electronic purchase of an airline ticket that results in the generation of the boarding pass shown in FIG. 15 can result in a “yes” determination being made at block 510. (Note that during a subsequent cycling of method 500, the generation of the boarding pass shown in FIG. 15, in and of itself, would not constitute account activity, as a “yes” determination will have been achieved once during cycling of method 500.)

To assist with explanation of method 500, assume that prior to performance of method 500, the dynamic content stored on server 86a was in the form of content 91a-1 as shown in FIG. 14. Next, assume that subsequent to generation of display 224a-B in FIG. 14, the airline ticket corresponding to the boarding pass in FIG. 15 is electronically purchased and associated with account “555 555 555”. Thus, in these assumptions, method 500 advances from block 510 to block 515.

Block 515 comprises a determination of the type of account activities. In the specific example being discussed, it is determined that the type of account activity is a purchase of an airline ticket. Note it is contemplated that a plurality of activities may have occurred, and so a plurality of determinations may be made. For example, multiple airline tickets may have been purchased—e.g. an outbound flight ticket, and a return flight ticket.

Block 520 comprises prioritizing the activities, if there have been multiple activities. In the example of multiple plane tickets, then the prioritization can be based on ranking the outbound flight as first, and the return flight as second.

Block 525 comprises updating dynamic content according to the priorities from block 520. In the airline ticket example, where there is a single airline ticket purchase, then, at block 525, content 91a-1 (as shown in FIG. 14) may be changed to content 91a-1-A (as shown in FIG. 15). At this point method 500 cycles back to block 510.

A “no” determination at block 510 leads to block 530 where a determination is made if the dynamic content is stale. The means for making a “yes” determination at block 530 are not particularly limited can comprise a simple timer where if there has been no account activity for a given time period (e.g. weeks, months, years), or there has never been account activity, then a “yes” determination is made at which point at block 540 is reached. Block 540 can comprise deleting any existing dynamic content (e.g. if the flight associated with content 91a-1-A has already occurred then content 91a-1-A may be deleted. However, the completion of the flight may also be deemed “account activity” leading to a “yes” determination at block 510). Block 540 can also comprise populating dynamic content 91a with generic content (thereby obviating the need for the decision box at block 425 and block 430). Such a generic message can comprise, for example “Welcome to ZZZ Airlines”, or other generic message already discussed. Method 500 returns to block 510 from block 540.

A “no” determination at block 530 leads to block 535, at which point no change is made to the dynamic content and method 500 returns to block 510.

Variations on method 500 are contemplated. For example, the determination whether dynamic content is “stale” and the associated actions (i.e. blocks 530, 535 and 545) can be performed locally by device 54a. In this example, device 54a may be configured to delete dynamic content after a predefined period of time and then to substitute such deleted dynamic content with generic content.

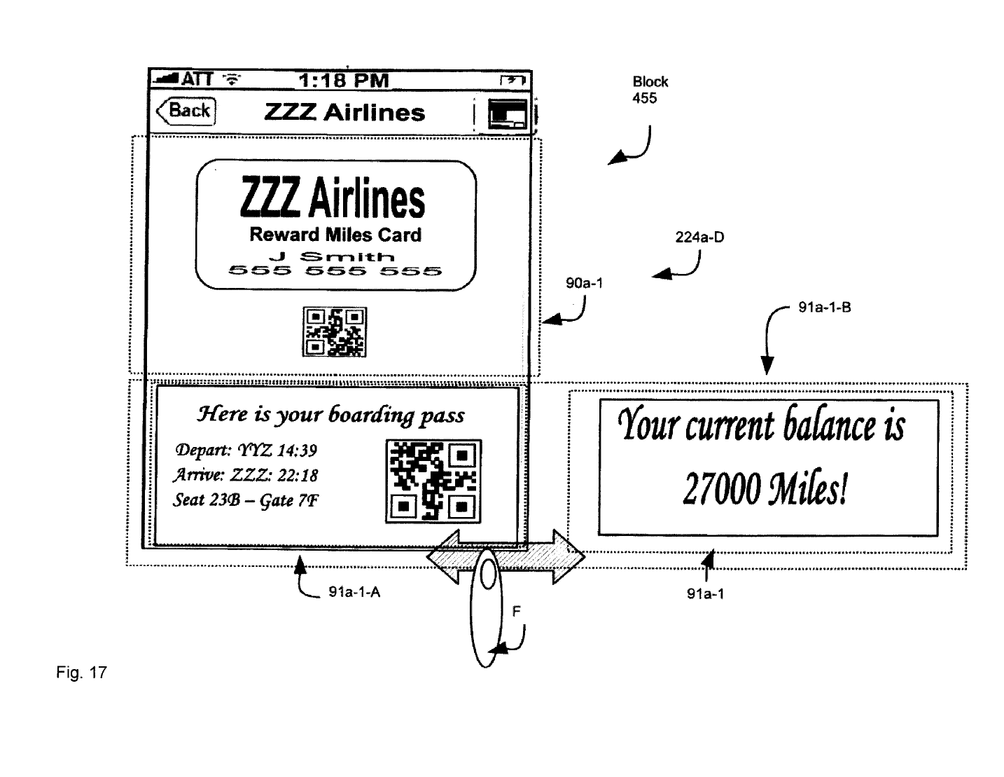

As another example, it is contemplated that dynamic content 91a generated at block 525 can have multiple views which can be scrolled via touch screen 202 (or other input device) while content 90a-1 remains static. Accordingly, at block 525, dynamic content that is created can be created to have such scrollable multiple views. FIG. 17 shows a non-limiting example of multiple-view dynamic content 91a-1-B which itself comprises both content 91a-1-A (from FIG. 15) and content 91a-1 (from FIG. 14). A finger F can be used to “swipe” the area of touch screen 202 that corresponds to dynamic content 91a to scroll between content 91a-1-A and content 91a-1. Those skilled in the art will recognize that the example in FIG. 17 would be generated at block 455 after performance of block 525 to create content 91a-1-B.

As another example, dynamic content 91a can comprise embedded links, which can be selected in order to activate a web page or other applications or other content associated with such links.

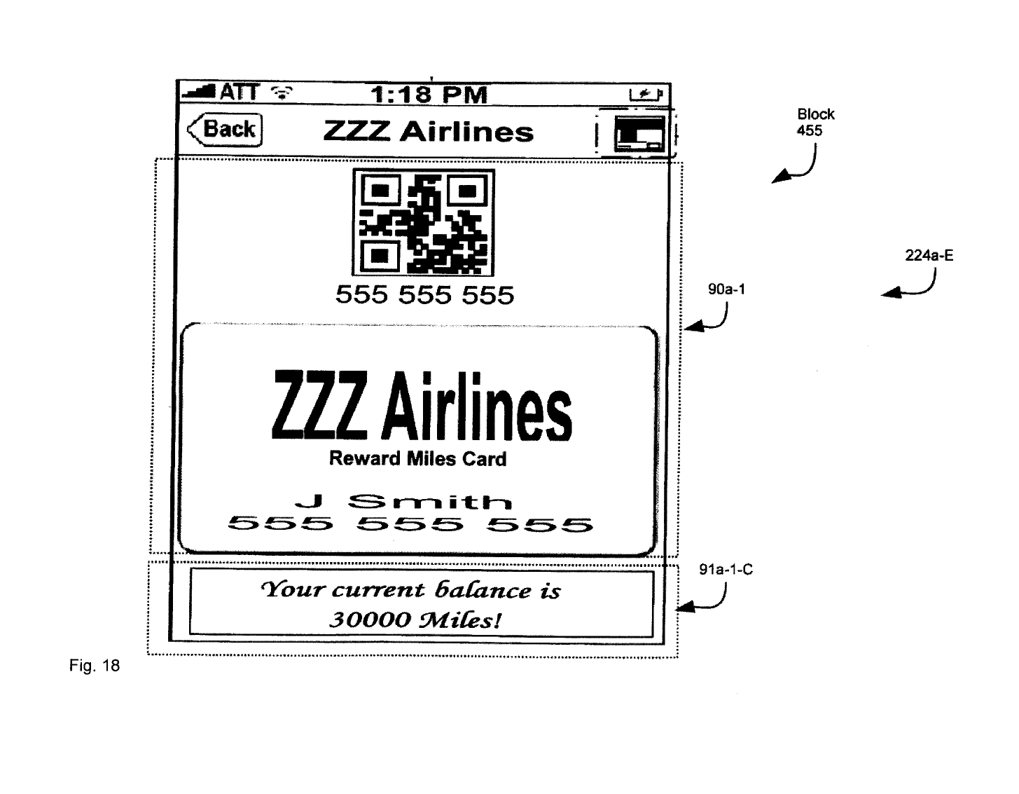

It will now be apparent that subsequent performances of method 500 can lead to continual updates to dynamic content 91a. For example, FIG. 18 shows an update to dynamic content 91a in the form of dynamic content 91a-1-C showing the miles balance for account 555 555 555 has increased from 27,000 miles to 30,000 miles.

A practical illustration will also now be apparent. Display 224a-B shown in FIG. 14, with dynamic content 91a-1 indicating a balance of 27,000 miles can be an initial state of system 50a. Display 224a-C shown in FIG. 15 can show the update to dynamic content 91a-1-A, in the form of a boarding pass that can be used to effect boarding of a plane for a booked flight. Assume that the flight is also “worth” 3,000 new miles. Therefore, immediately upon completion of the flight, link 66a can be reactivated leading to a performance of method 500 that updates dynamic content 91a-1-A to dynamic content 91a-1-C. Subsequent performance of method 400 results in generation of display 224a-E in FIG. 18, indicating that 3,000 more miles have now been added to account 555 555 555, bringing the total number of miles to 30,000 as shown in FIG. 18.

It is also to be understood that the types and nature of dynamic content 91a are not particularly limited, though are generally logically related or associated with a given record 90a. For example, where record 90a is a representation of an event ticket (discussed above), then dynamic content 91a can initially be a pre-event coupon for a restaurant outside the event, and during the event, the dynamic content 91a can change to a coupon for a concession stand within the event. Furthermore, the dynamic content may contain a barcode or other machine readable indicia to facilitate or track redemption of any service or other value associated with the dynamic content.

Table III below shows further examples of dynamic content.

TABLE III
Examples of records and dynamic content

| Example record 90a | Examples of dynamic content 91a |
|---|---|
| Airline “Air Miles” card | Reward balance |
| | Boarding pass |
| | Seat sales |
| Event ticket | Coupon for restaurant prior to event |
| | Coupon for venue within event |
| Retail Loyalty Card | Reward balance |
| | Coupons |
| Bank Debit Card | Financial Account Balance |
| | Mortgage rates |
| | Credit card rates |
| University Identification | Campus announcements |
| Card | Student loan application status |
| Employment benefits | Benefits claim redemption status tracking |
| card | Balance of personal health spending account |
| Retail gift card | Remaining balance on gift card |
| | Promotional offer to create a loyalty account. |
| | (e.g. bonus loyalty account points) |
| | Coupon redeemable in conjunction with gift |
| | card |
| Fan-club card for artist or | Coupon offering for discount on media release |
| media program | via DVD, CD or iTunes |
| | Schedule for upcoming live performance |
| | Opportunity to enter contest via SMS or other |
| | electronic message |

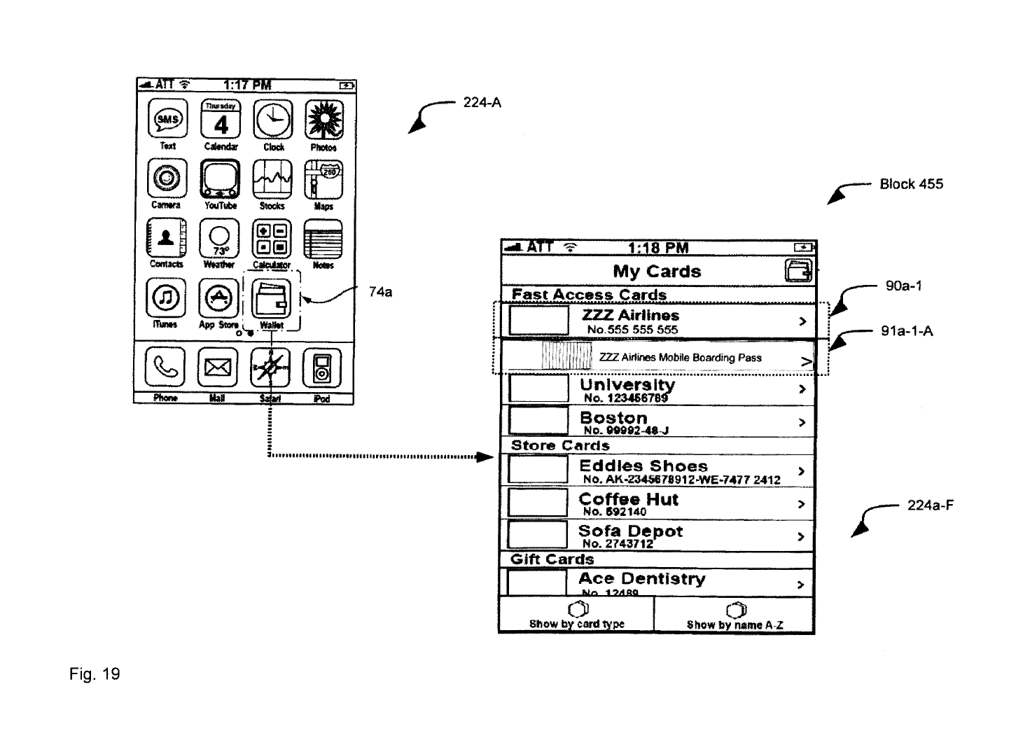

A further variation on the foregoing is shown in FIG. 19. In FIG. 19, display 224a-F is generated directly from display 224a. Display 224a-F is analogous to display 224-B and 224a-A, except that a link to dynamic content 91a-1-A is also included in relation to the link to record 90a-1. Method 400 can be varied in order to generate display 224a-F, where the invocation of the “wallet” application 74 from the menu on display 224-A results in deemed invocation of method 400 for every record 90a within application 74a. Accordingly, method 400 executes for every record 90a. As a simple example, only record 90a-1 has dynamic content 91a-1-A and so when the link for record 90a-1 is generated on display 224a-F, the link for dynamic content 91a-1-A is also generated on display 224a-F. To the extent other artifacts or records 90a have dynamic content 91a, then such dynamic content 91a can likewise be generated on display 224a-F.

It is to be understood that variations, sub-sets and combinations of the foregoing are contemplated, and that the scope of the exclusive privilege of this specification is defined by the claims. For example, as a variation of block 450, the contents of record 90a-1 can also be downloaded dynamically over network 58a, rather than being retrieved locally on device 54a-1.

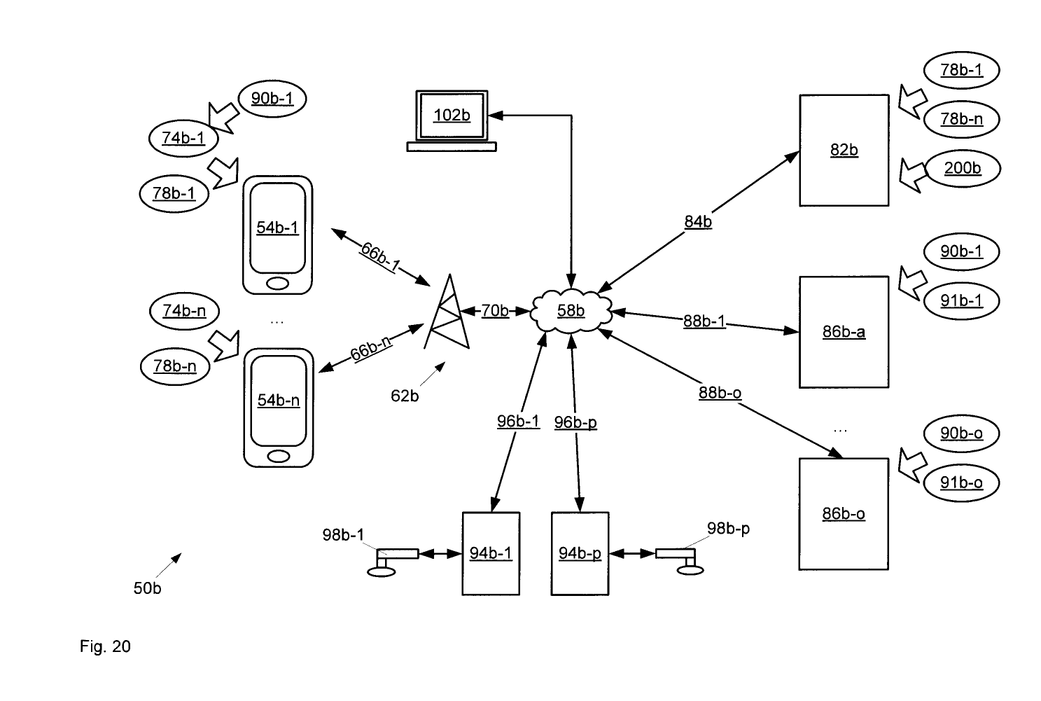

Referring now to FIG. 20, according to another embodiment a system for management of electronic wallet databases is indicated generally at 50b. System 50b is a variation on system 50a, and accordingly, like elements bear like references, except the suffix “b” is included for elements in system 50b. Of note is that in system 50b, server 82b optionally comprises an installation file 200b which comprises installation data for installing universal wallet application 74b.

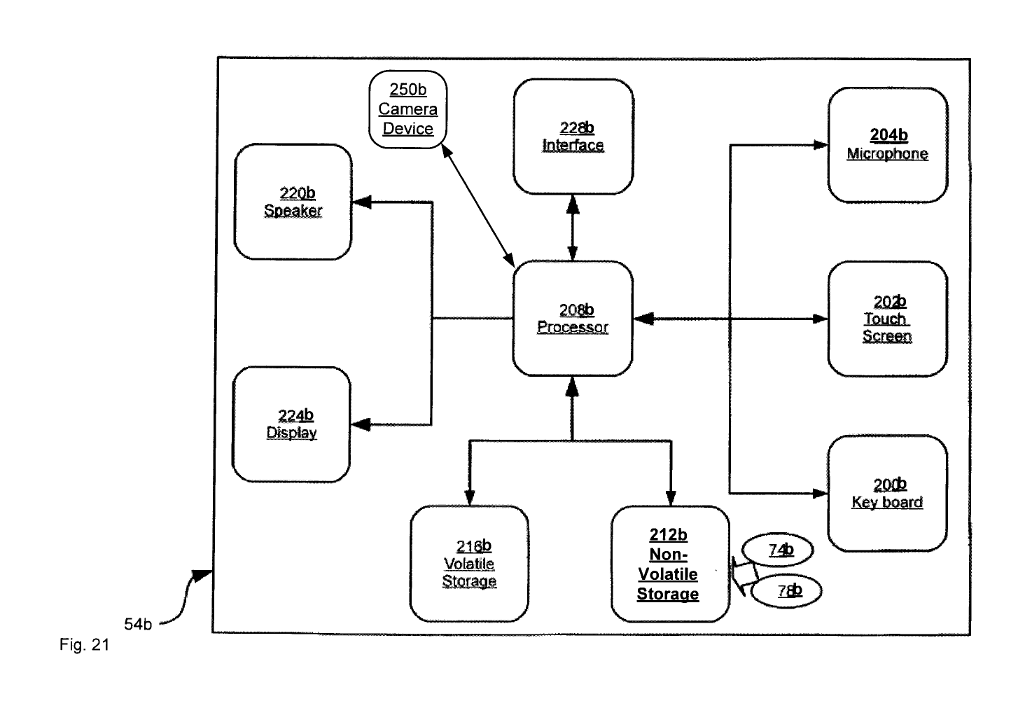

With reference to FIG. 21, device 54b is similar to device 54 depicted in FIG. 2, with like elements having like number with a “b” appended thereto. However device 54b further comprises a camera device 250b for acquiring visual artifacts encoded with content for acquiring electronic data records 90b associated with dynamic content 91b, as will be explained in further detail hereafter.

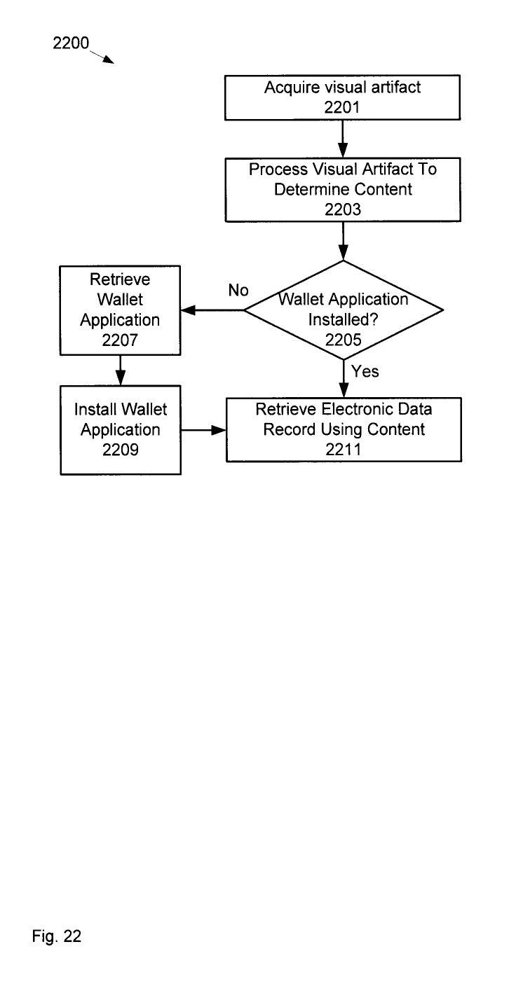

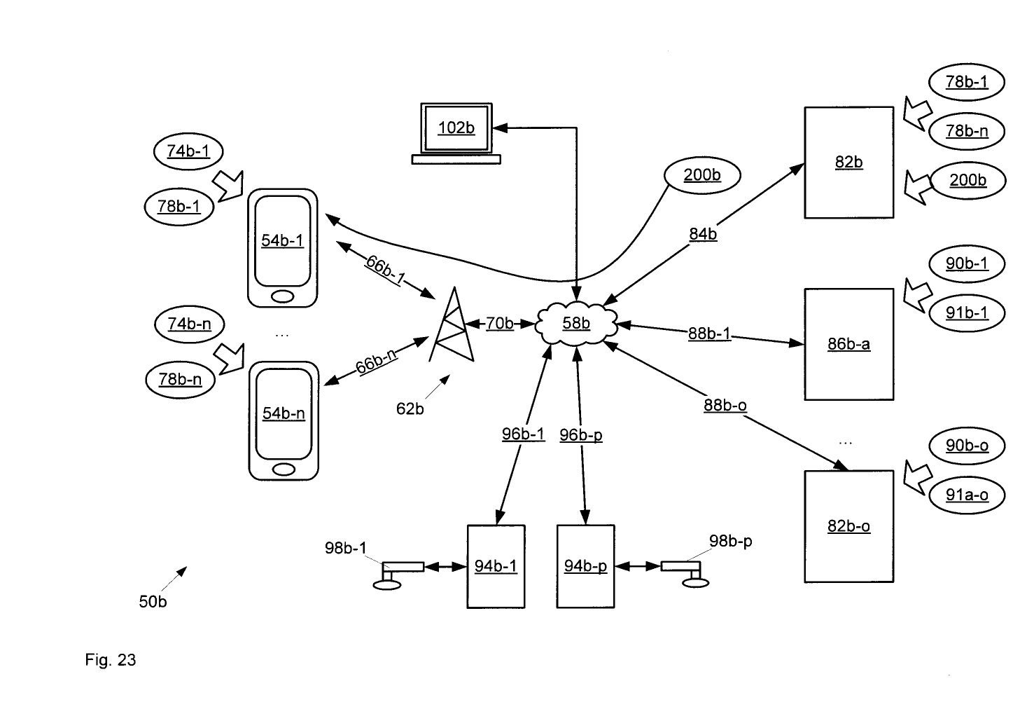

Referring now to FIG. 22, a method for acquiring electronic data records 90b at device 54b is depicted in the form of a flow-chart and indicated generally at 2200. Method 2200 can be explained using system 50b, and in the context of device 54b-1, and servers 82b, 86b, but it will be understood that method 2200 can be implemented on variations of system 50b. In the following description, it will be assumed that device 54b-1 initially has no data record 90b stored thereon, as depicted in FIG. 23.

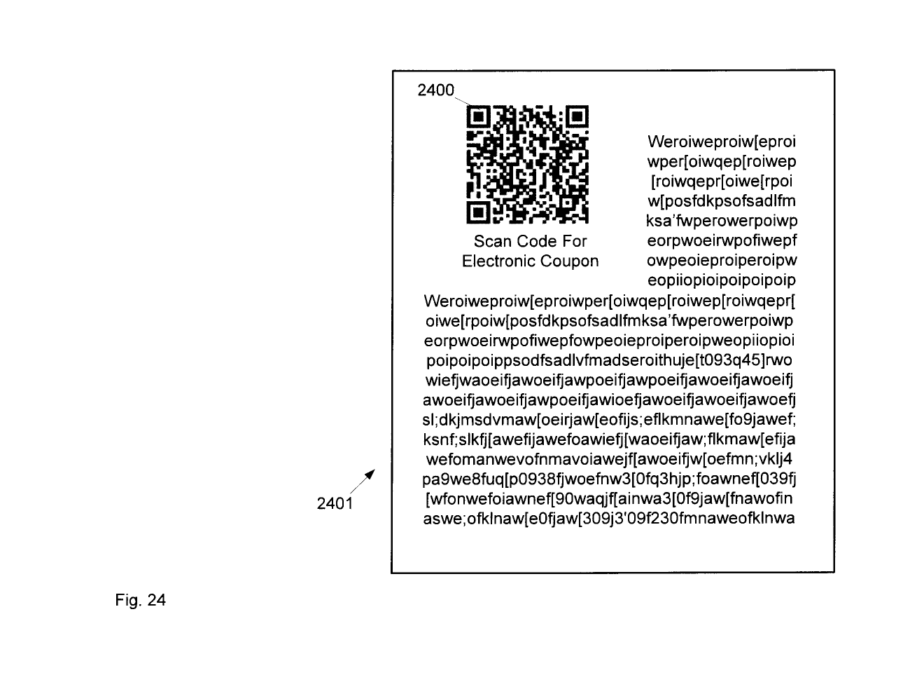

It is further understood that a visual artifact 2400, as depicted in FIG. 24, has been generated which comprises encoded data for retrieving installation file 200b, and data for retrieving electronic data records 90b. For example, visual artifact 2400 can have been generated by any one of servers 82b, 86b, or any other suitable server and/or computing device, and then included in printed material 2401 such as a magazine, advertising material, gift card packaging or the like, as will be explained in further detail below.

Returning to FIG. 22, at block 2201, visual artifact 2401 is acquired at device 54b-1, visual artifact 2401 encoded with content for acquiring electronic data record 90b associated with dynamic content 91b. At block 2203, device 54b-1 processes visual artifact 2401 to determine the content encoded therein.

For example, in some implementations device 54b-1 comprises an application for acquiring and decoding visual artifacts, including but not limited to QR (quick response) Codes, barcodes and the like, using a camera device such as camera device 250b. In implementations described herein, visual artifact 2400 comprises a QR Code, as depicted in FIG. 24.

In general visual artifact 2400 is encoded with content for acquiring electronic data record 90b associated with dynamic content 91b, and visual artifact 2400 is optionally further encoded with retrieval content for retrieving electronic wallet application installation file 78b-1. In general data encoded at visual artifact 2400 comprises novel custom uniform resource identifier (“URI”) schemes to pass various forms of data, and/or references to that data, similar to those described above. An example of a custom URI encoded in visual artifact 2400 is provided hereafter:

http://someDomain.com/mobi/qrshort?action=request_card&issuer_id=12&issuer
_name=Mega Book Store

URI 1

When the application at device 54b-1 for reading visual artifacts acquires and decodes visual artifact 2400, the URI above is acquired. The first section of URI 1 which reads “http://someDomain.com/mobi/qrshort” comprises an envelope portion which in turn comprises data that causes a browser application at device 54b-1 to launch and go to address “http://someDomain.com/mobi/qrshort” to retrieve electronic wallet application installation file 78b-1. In other words, “someDomain.com” comprises an IP (Internet Protocol) address for a given server 82b, and “/mobi/qrshort” comprises a destination URI, or the like, at server 82b where electronic wallet application installation file 78b-1 is stored.

Hence, returning to FIG. 22, at block 2205, when electronic wallet application 74b is not installed at device 54b-1, device 54b-1 retrieves electronic wallet application 74b in the form of electronic wallet application installation file 78b-1, as depicted in FIG. 23, and installs electronic wallet application 74b at device 54b-1 at block 2209 such that electronic wallet application is thereafter stored at non-volatile storage 212b, as depicted in FIG. 21.

However, when electronic wallet application 74b is installed at device 54b-1, device 54b-1 proceeds from block 2205 or block 2209 to block 2211 where electronic data record 90b-1 is retrieved using the remaining content from the URI. Respective to URI 1 above, the remaining content comprises:

“action=request_card&issuer_id=12&issuer_name=Mega Book Store”.

Hence it is appreciated that “?” is a delimiter, separating the envelope portion from the content for retrieving data record 90b-1, in accordance with the URI standard referenced above.

In URI 1, the content for retrieving data record 90b-1 comprises parameters for instructing electronic wallet application 74b for retrieving data record 90b-1 from server 86b-a. Specifically, “action=” instructs electronic wallet application 74b that data following “=” comprises instructions which electronic wallet application 74b is to process. “request_card&issuer_id=12&issuer_name=”Mega Book Store”” indicates that an electronic card associated with an issuer with identification number “12” and a name “Mega Book Store” is to be retrieved from server 86b-a, for example via a web service call and/or a private web service call, the latter to securely retrieve electronic data record 90b-1

In some implementations, server 86b-a can be identified via universal wallet data file 78b and/or a database associated with electronic wallet application 74b, in which, for example, identifier “12” is associated with an IP address and/or or a domain name of server 86b-a. Alternatively, an IP address of server 86b-a can be included in the content for retrieving data record 90b-1. The name “Mega Book Store” can be used in a Graphic User Interface (GUI), as described below.

In implementations where electronic wallet application 74b has been previously installed at device 54b-1, method 2200 can be implemented within electronic wallet application 74b. In other words, electronic wallet application 74b is enabled to use camera device 250b to acquire visual artifact 2400, and blocks 2205 to 2209 of method 2200 are skipped; in addition, the envelope portion of the URI for retrieving electronic wallet application 74b is not processed and electronic wallet application 74b proceeds to process the content for retrieving electronic data record 90b-1.

It is furthermore appreciated that dynamic content 91b-1 can be retrieved along with electronic data record 90b-1, and/or after electronic data record 90b-1 has been retrieved, for example using a method similar to method 400 and/or method 500. Alternatively, dynamic content 91b-1 can be retrieved instead of electronic data record 90b-1, for example in implementations where electronic data record 90b-1 is already stored at device 54b.

For example, implementations where dynamic content 91b-1 is retrieved along with and/or instead of electronic data record 90b-1, a suitable URI can include content for retrieving dynamic content 91b-1, such as:

http:///someDomain.com/mobi/qrshort?action=request_reward&parent_id=49&pa
rent_name=Young Readers Card”.

URI 2

The envelope portion of URI 2 is similar to URI 1 above, however the action to be performed comprises requesting the latest rewards associated with a parent identification number “49”, for example a loyalty card associated with the parent identifier. In other words, in these implementations, electronic data record 90b-1 comprises a loyalty card identified by electronic wallet application 74b via parent identifier “49”.

It is further appreciated that the content portion of URI 2, “action=request_reward&parent_id=49&parent_name=Young Readers Card” could also be provided as in URI 1, as a second action to be performed.

Hence, method 2200 comprises a method for: acquiring at a portable electronic device a visual artifact encoded with content for acquiring an electronic data record associated with dynamic content; processing the visual artifact to determine the content; and retrieving the electronic data record from a remote server via a network connection by processing the content at the portable electronic device. The content can comprise electronic data record 90b and/or dynamic content 91b. It is further appreciated that electronic data record 90b can comprise at least one of a business card, a vanity card, a loyalty card, a gift card, a stored value card, an identification card, a retail coupon, a manufacturers coupon, an event badge, a receipt, an event ticket, and a subscriber pass, as described above, and dynamic content 91b can comprise content suitable for the associated electronic data record 90b.

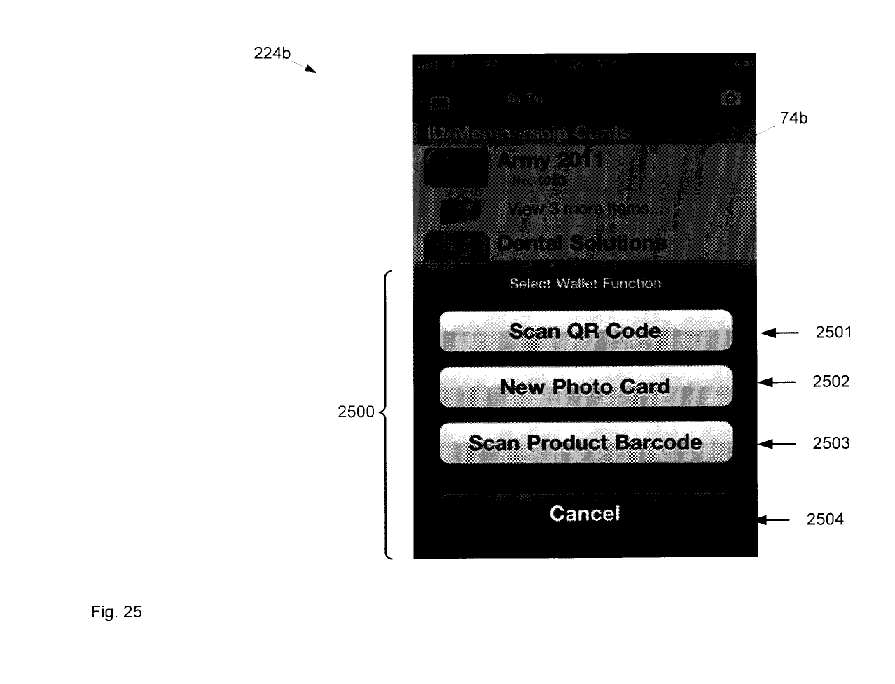

Attention is next directed to FIGS. 25-30 which each depict aspects of a GUI associated with electronic wallet application 74b rendered at display 224b.

FIG. 25 depicts a GUI similar to those depicted in FIGS. 4 to 8, however in FIG. 25 a “Wallet Function” option has been selected to cause a “Select Wallet Function” menu 2500 to be rendered at display device 224b, menu 2500 comprising an option 2501 to scan a QR code, an option 2502 to acquire a new camera card, an option 2503 to scan a product bar code, and an option 2504 to cancel and return to a main screen of the GUI. Menu 2500 can be invoked in any suitable manner, including but not limited to a pull down menu, a virtual button in the GUI, a physical button at device or the like.

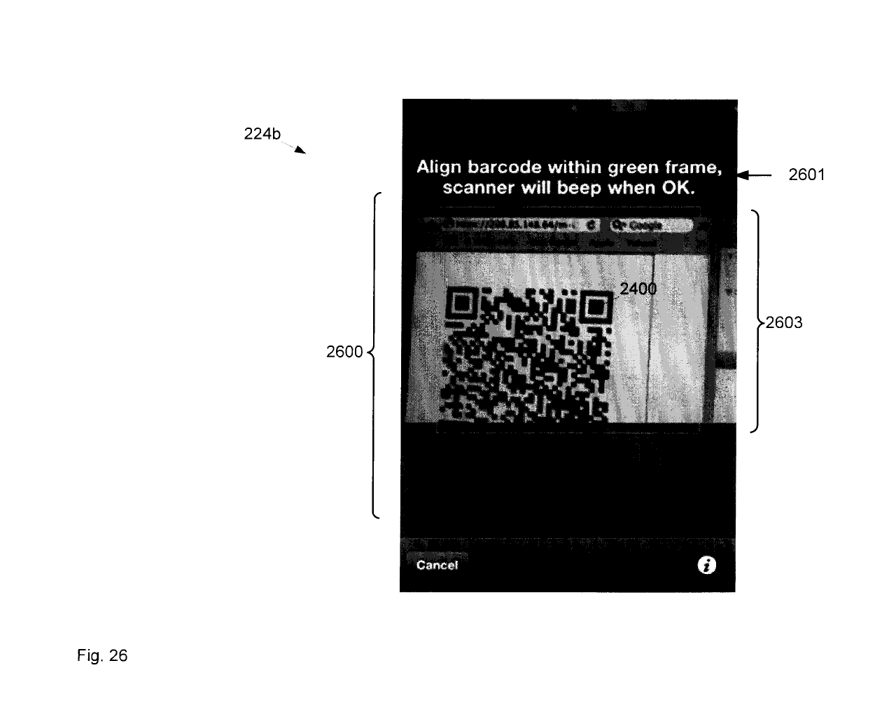

Attention is next directed to FIG. 26, which assumes that option 2501 has been selected, for example via touchscreen input, pointer input, or the like. As understood from FIG. 26, camera device 250b is invoked to acquire a digital image of visual artifact 2400, which in FIG. 26 is seen in a viewfinder 2600 associated with camera device 250b. Instructions 2601 are provided to assist a user with aligning visual artifact 2400 with an area 2603 in which visual artifact 2400 is to be aligned to capture a suitable digital image thereof. In some implementations, a non-limiting scanner application causes the digital image of visual artifact 2400 to be captured at device 54b-1 once suitable alignment occurs in area 2603. In general, it is appreciated that FIG. 26 is representative of block 2201 of method 2200.

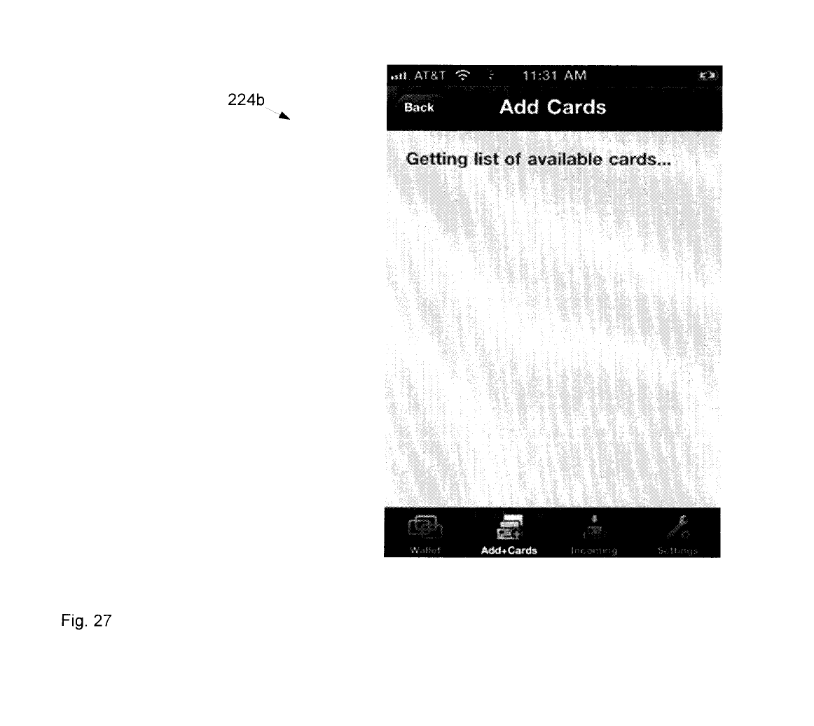

Once visual artifact 2400 has been processed at block 2203, the GUI is updated as in FIG. 27. It is assumed in FIG. 27 that the URI encoded in visual artifact 2400 has been acquired and that a request for electronic data record 90b has been transmitted to server 86b. Indeed, it is appreciated that FIG. 27 is merely a placeholder screen indicating that a list of electronic data records 90b that are available from server 86b is being retrieved (i.e. the message “Getting list of available cards . . . ” is provided).

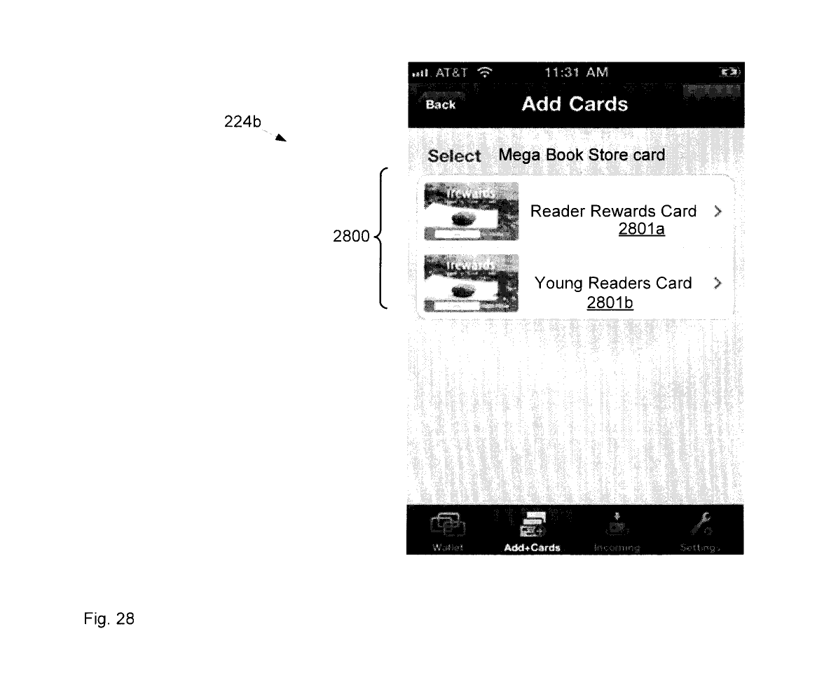

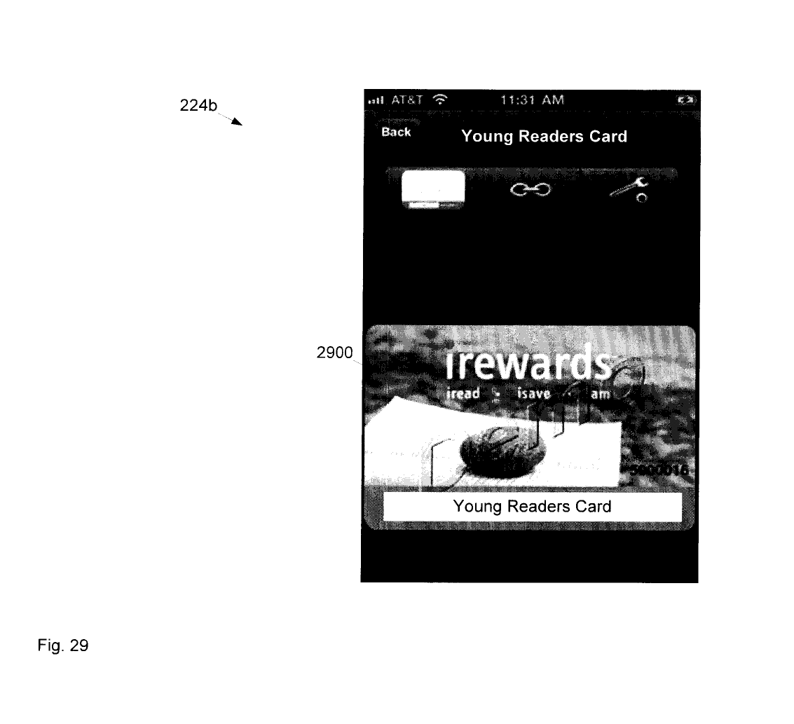

At FIG. 28, a list 2800 of electronic data records 90b available from server 86b is rendered. In depicted implementations, it is understood that two electronic data records 90b are available from server 86b, as represented by virtual buttons 2801a, 2801b, each representative of different loyalty rewards cards available from a business named “Mega Book Store”. Indeed, the name of the business rendered at the screen of FIG. 28 can be provided from the “issuer_name” field from URI 1. In present non-limiting example implementations, it is assumed that virtual button 2801b has been selected and that an electronic data record 90b corresponding to a loyalty rewards card called “Young Readers Card” is to be downloaded. At block 2211 of method 2200, the corresponding electronic data record 90b is retrieved, including a representation thereof, and a representation 2900 of the corresponding electronic data record 90b is then rendered at display device 224b, as depicted in FIG. 29.

Dynamic content 91b can be retrieved when electronic data record 90b is retrieved and/or dynamic content 91b can be retrieved thereafter. In some implementations, dynamic content 91b associated with electronic data record 90b can be requested by returning to menu 2500 of FIG. 25 and scanning a second visual artifact corresponding to URI 2 above, as in FIG. 26. Again the envelope portion is ignored, and rewards (i.e. dynamic content 91b) associated with the loyalty reward card (i.e. electronic data record 90b) are requested from server 86b.

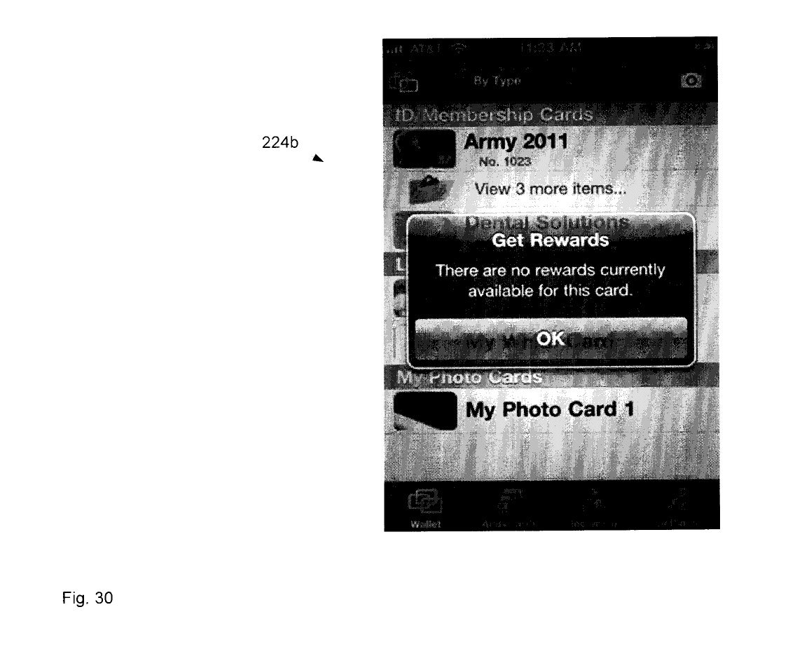

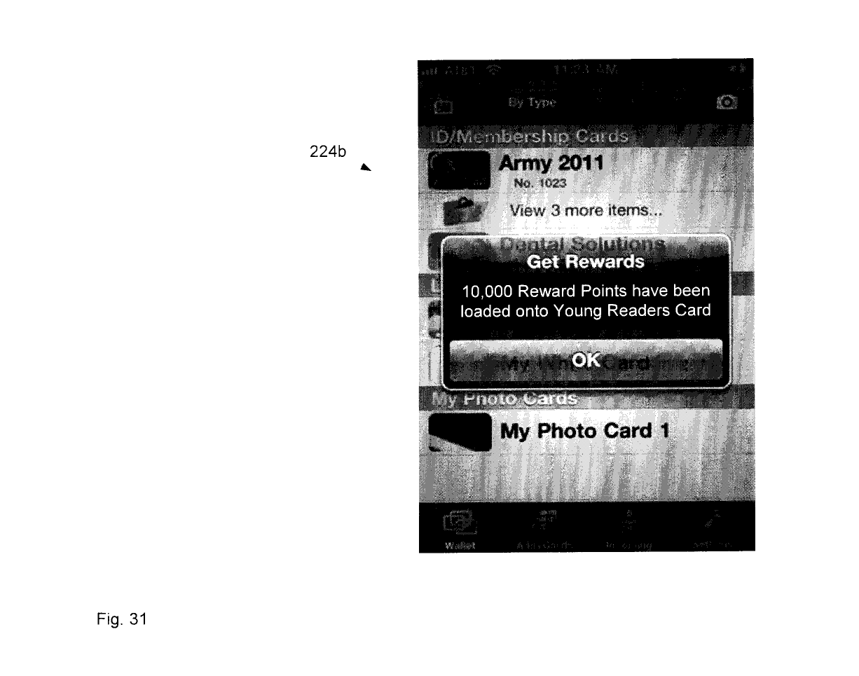

In any event, when dynamic content 91b is not available and/or no new dynamic content is available, a screen corresponding to FIG. 30 is rendered indicating that no rewards/dynamic content 91b are currently available. When dynamic content 91b is available and retrieved, a screen corresponding to FIG. 31 is rendered indicating that rewards/dynamic content 91b has been downloaded and loaded onto the associated card (i.e. dynamic content 91b is stored in association with electronic data record 90b at device 54b).

It is further appreciated that FIGS. 25 to 29 disclose a variation on block 2211 of method 2200, wherein retrieving electronic data record 90b from server 86b comprises: retrieving a plurality of indications respectively representative of a plurality of available electronic data records 90b available for download; receiving input indicative of a choice of one of the plurality of available electronic data records 90b, wherein the choice is indicative of a selected electronic data record 90b; and requesting the selected electronic data record 90b. FIGS. 25, 26, 30 and 31 disclose yet a further variation on block 2211 in which an indication of dynamic content 90b associated with electronic data record 90b is received and a representation of at least one of electronic data record 90b and dynamic content 91b is rendered.

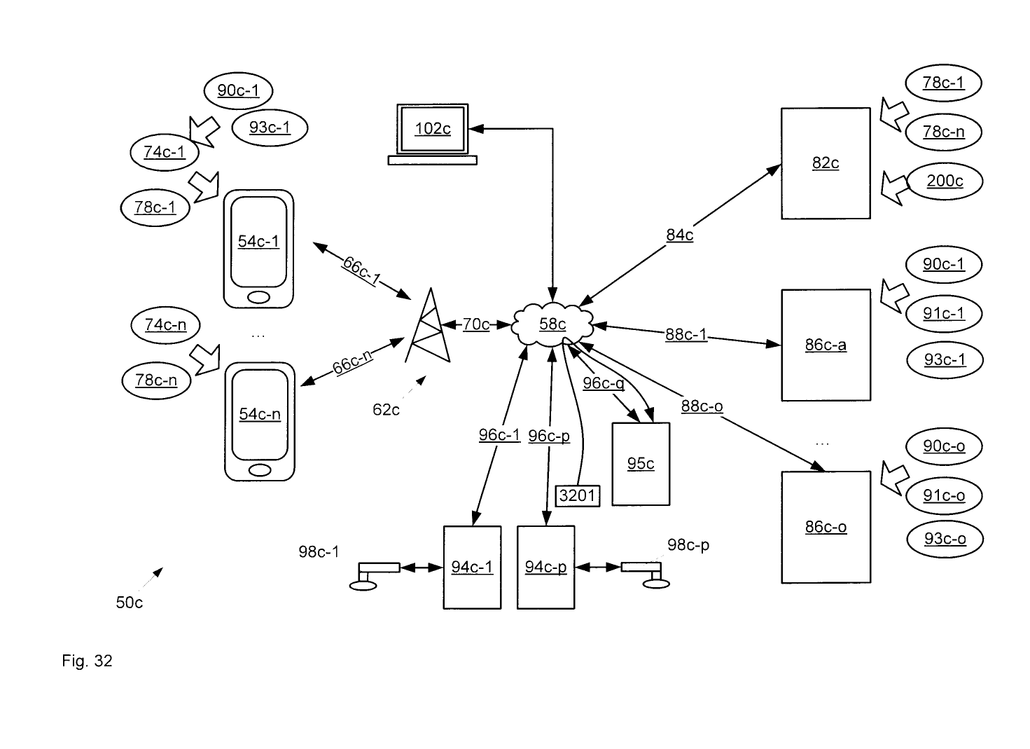

It is appreciated that yet further variations and alternatives to method 2200 are within the scope of present implementations. For example, attention is directed to FIG. 32 which is substantially similar to FIG. 20, with like elements having like numbers, however with a “c” appended thereto. However in these implementations, servers 86c further store, and/or are enable to generate, validation data 93c for validating electronic data records 90c and/or dynamic content 91c, as described hereafter. Furthermore, system 50c comprises a payment server 95c for processing payments in communication with network 58c via a suitable link 96c-q.

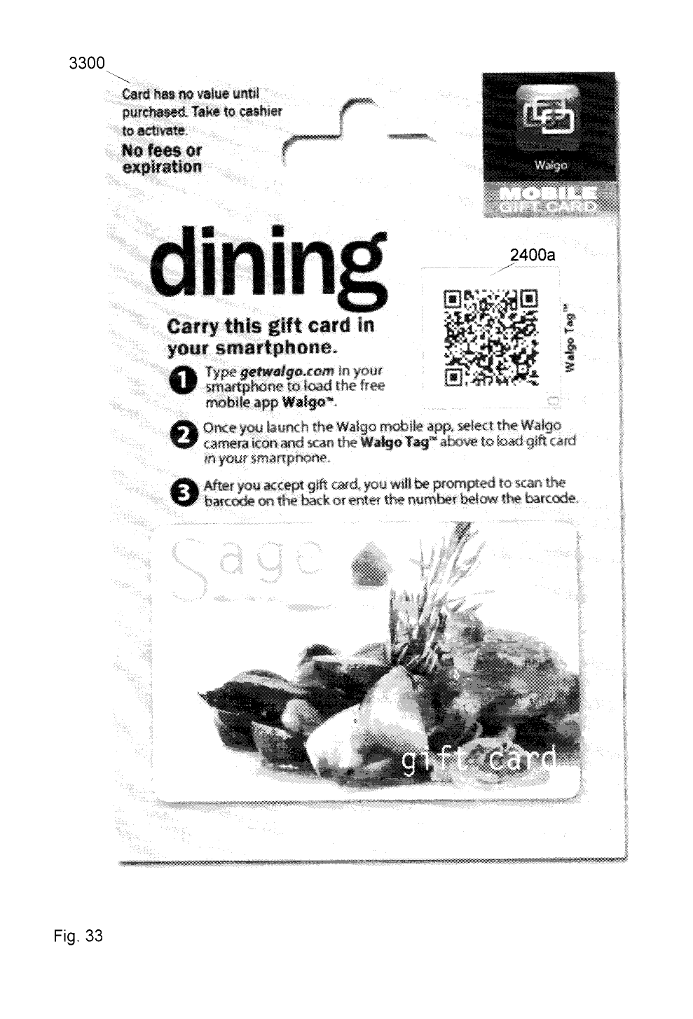

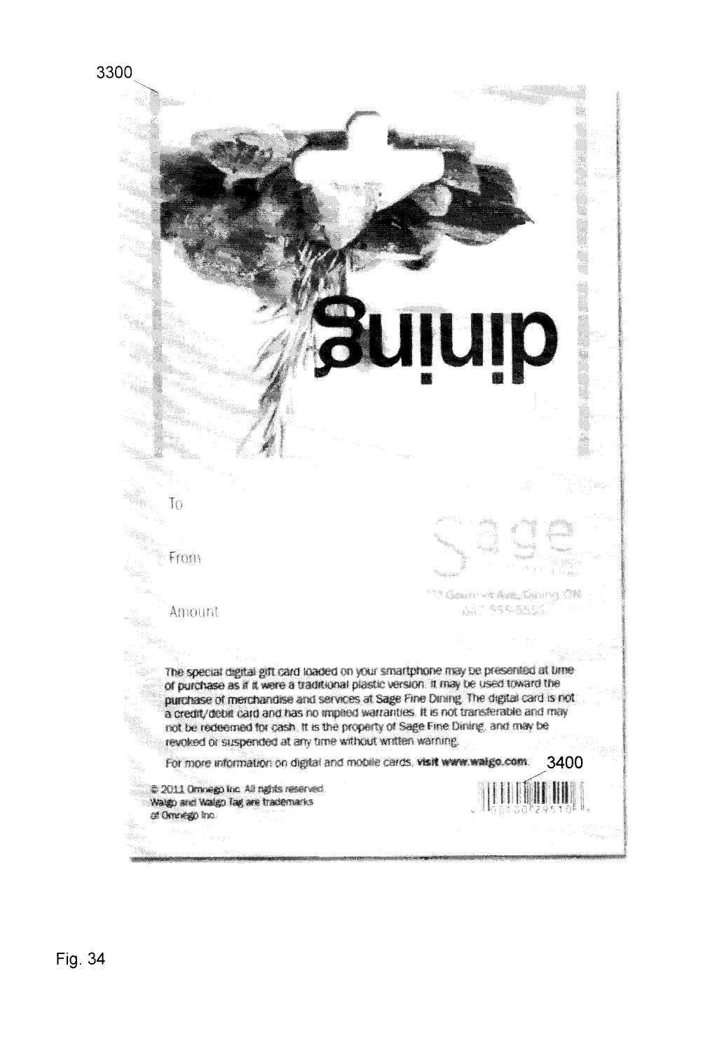

For example, depicted in FIGS. 33 and 34 are representations of respectively the front and back of printed gift card packaging 3300 that can be purchased at a suitable retail outlet. It is appreciated that packaging 3300 does not include a physical gift card, though a rendering thereof is printed thereon, but rather comprises a visual artifact 2400a, similar to visual artifact 2400, for retrieving an electronic data record 90c corresponding to a gift card, as well as a bar code 3400 which can be used to validate electronic data records 90c and/or dynamic content 91c associated with visual artifact 2400a.

For example, a consumer could retrieve packaging 3300 from a display case for purchase in a retail outlet and bring packaging 3300 to a checkout configured with a proximity reader 98c-1 (e.g. a barcode reader). Barcode 3400 is then scanned, which triggers the associated reader server 94c-1 to transmit a request for validation data 93c-1 to server 86c-a, which then returns validation data 93c-1 to reader server 94c-1. For example, validation data 93c-1 can comprise a PIN code or the like of any suitable length. The PIN code or the like is then provided to the consumer, either in an electronic form, a form that can be scanned by device 54c, a form that can be entered into device 54c via a suitable input device, or any other suitable form.

In any event, once visual artifact 2400a is acquired at device 54c, as in block 2201 of method 220 described above, an additional step of requesting validation data 93c occurs, validation data 93c being acquired via any suitable manner appropriate to the form of validation data 93c including but not limited to an electronic transfer of validation data 93c, scanning of a suitable visual artifact, entry of a PIN code and the like.

When validation data 93c is acquired at device 54c, a copy of validation data 93c can be requested from server 86c for comparison. If validation data 93c matches the copy, the gift card is validated and dynamic content 91c representative of the dollar amount to be loaded onto the gift card is retrieved, otherwise validation data 93c can be re-requested and/or validation fails and dynamic content 91c is not retrieved.

However, any suitable variation on this process is within the scope of present implementations. For example, barcode 3400 can be provided on a printout behind the checkout counter, and not printed on packaging 3400 such that the consumer has no access to barcode 3400, but a clerk operating proximity reader 98c-a has access to the barcode. Similarly, validation data 93c can be stored at reader server 94c-1, having being retrieved from server 86c in a provisioning process that can occur when the retail outlet stocks packaging 3400, or at any other suitable time. Further, validation data 93c can be encoded in visual artifact 2400a such that a further request to server 86c for validation data 93c does not occur; rather validation data 93c acquired at device 54c via the interaction with the checkout counter is compared to validation data 93c encoded in visual artifact 2400a.

In any event, it is appreciated that in some implementations dynamic content 91c comprises electronic rewards, and receiving validation data 93c for validating electronic data record 90b and/or dynamic content 91c occurs such that the electronic rewards can be transferred to a payment server 95c, as will be presently described.

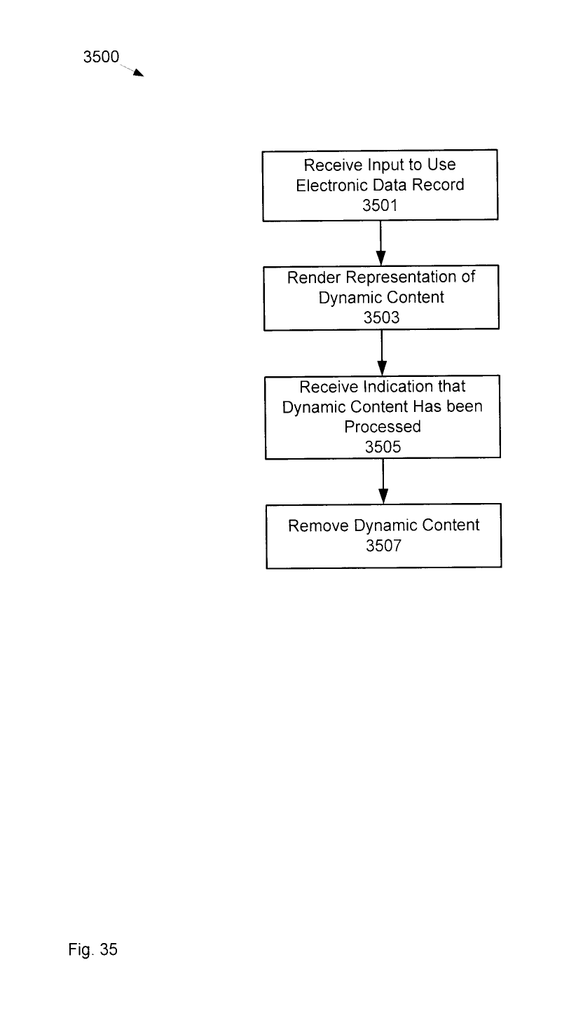

Attention is now directed to FIG. 35 which depicts a method 3500 for transferring dynamic content associated with an electronic data record to a payment server or the like. Method 2200 can he explained using system 50c, and in the context of device 54c-1, and servers 86c, 94c, and 95c but it will be understood that method 2200 can be implemented on variations of system 50c. In the following description, it will be assumed that device 54c-1 has acquired both an electronic data record 90c-1 and dynamic content 91c-1 associated therewith; it is further assumed that electronic data record 90c-1 comprise an electronic gift card, and that dynamic content 91c-1 comprises a monetary amount that has been previously loaded onto the gift card, for example $150.

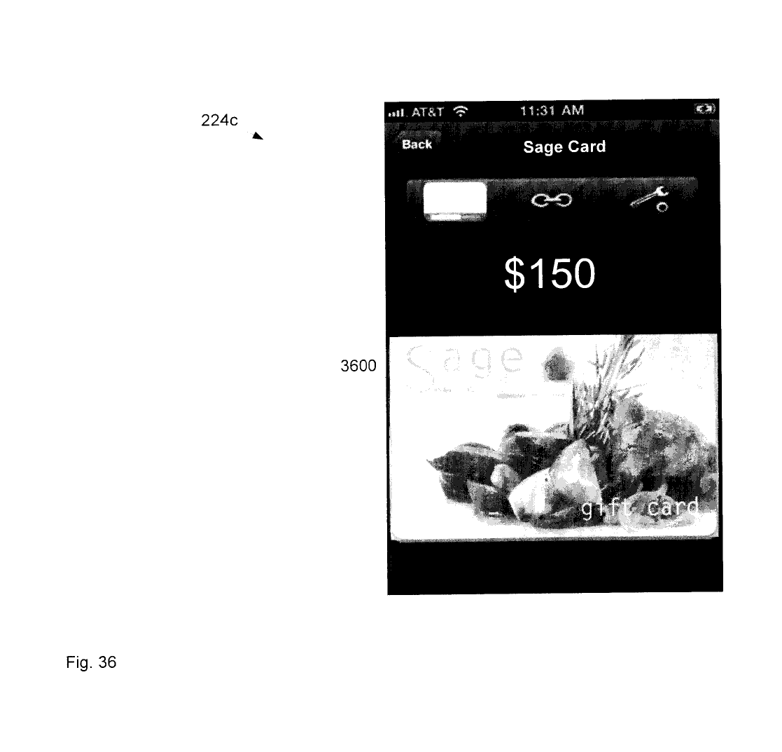

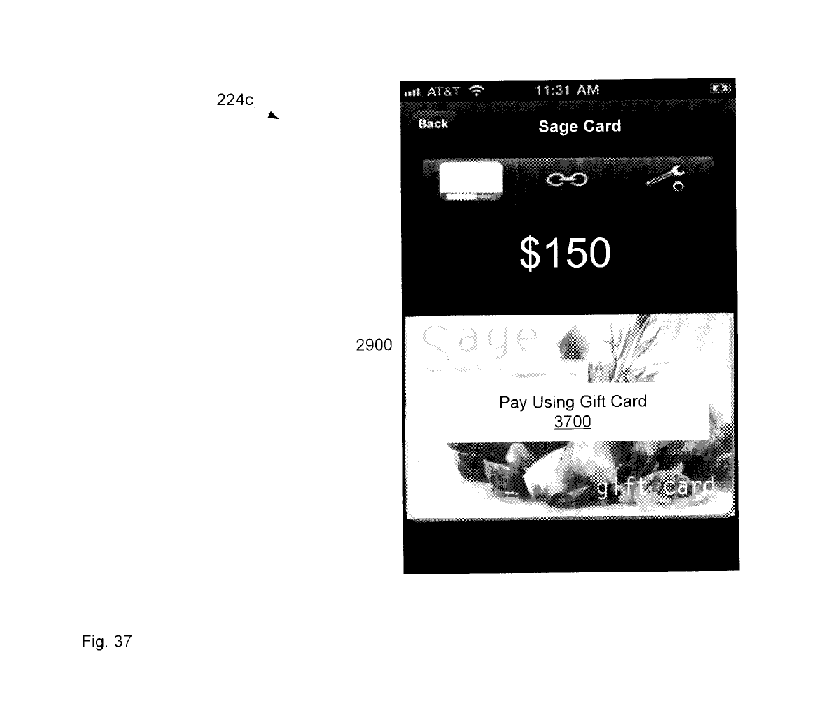

At block 3501, input is received indicative that electronic data record 90c-1 is to be used. For example, a representation 3600 of electronic data record 90c-1 is rendered as a display device 224c of device 54c-1, as depicted in FIG. 36. As appreciated from FIG. 36, the associated gift card has been loaded with $150. As depicted in FIG. 37, an option 3700 to use electronic data record 90c-1 and/or dynamic content 91c-1 (i.e. the $150) is provided, for example by selecting representation 2900 via a touchscreen or any other suitable input device, pulldown menu, or the like.

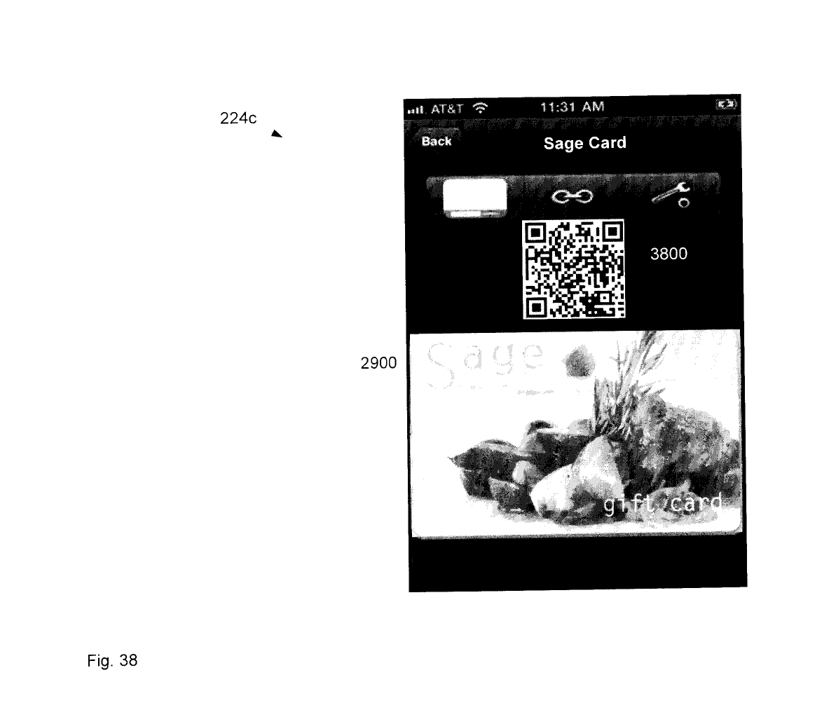

When option 3700 is selected, (and returning to FIG. 35) at block 3503, a representation 3800 of dynamic content 91c-1 associated with electronic data record 90c-a is rendered at display device 224c, as depicted in FIG. 38. In specific non-limiting example implementations, representation 3800 comprises a QR Code with the following data encoded therein: “Sage Gift Card $150 8 pm Mar. 3, 2011”. Hence, representation 3800 comprises a representation of an identifier of electronic data record 90c-1, “Sage Gift Card”, dynamic content 91c-1, “$150”, and an optional time stamp “8 pm Mar. 3, 2011”.

Using representation 3800, dynamic content 91c-1 can be acquired and processed at one or more of a reader server 94c and payment server 95c, as will be described below. It is further appreciated that in these implementations electronic wallet application 74c is enabled to generate representation 3800, either directly and/or via function call to a QR Code generator at device 54c. Further, while in depicted implementations, representation 3800 comprises a QR Code, in other implementations, representation 3800 can comprise any other suitable representation including but not limited a barcode, text or the like. Further, the data encoded in representation 3800 can be any suitable data but includes an indicator of dynamic content 91c-a. Further, encoding of data within representation 3800 can occur in any suitable manner.

In any event, when payment of the $150 is to occur, representation 3800 is generated at display device 224c, and display device 224c is provided to a suitable proximity reader 98c, such as proximity reader 98c-p and/or a suitable point-of-sale (POS) terminal. In latter implementations, a POS terminal can comprise reader server 94c-p and proximity reader 98c-p. Proximity reader 98c-p and/or POS terminal acquires an image of representation 3800 by scanning display device 224c, decodes data encoded therein and transmits the data along with any other suitable payment information (e.g. a total of a bill to be paid, credit card information or the like) to payment server 95c, via a request 3201 (as in FIG. 32), which processes the data for payment of a bill. Alternatively, representation 3800 can be transmitted to payment server 95c for decoding in request 3201, along with any other suitable payment information, as described above.

Returning to FIG. 35, at block 3505, device 54c receives an indication that dynamic content 94c-1 have been processed by one more of the POS terminal, payment server 95c and server 86c. For example, when such an indication is received from the POS terminal, the POS terminal can be enabled to communicate wirelessly with device 54c to transmit confirmation data that the payment has been processed, thereby triggering device 54c to remove/update dynamic content 91c-1 to decrease the amount loaded onto the gift card by the amount paid. In some implementations the confirmation can originate at payment server 95c, and payment server can transmit the confirmation to the POS terminal and/or server 86c. In the latter implementations, server 86c-a then transmits a confirmation to device 54c that payment has occurred and instructions to decrease the amount loaded onto the gift card by the amount paid. Alternatively, method 500 can be implemented such that dynamic content 91c-1 can be updated in a dynamic content refresh cycle between device 54c and server 86c-a.

In any event, at block 3507, dynamic content 91c-1 associated with the payment is then removed and/or updated from device 54c-1.

Other variations and alternatives are within the scope of present implementations. For example, rather than paying the full amount loaded onto the gift card, electronic wallet application 74c can be enabled to specify any amount to be paid, up to and including the full dollar amount loaded onto the gift card. For example, if the electronic gift card is loaded with $150, then in some implementations electronic wallet application 74c can be enabled to provide an optional input screen whereby an amount to be used for payment can be specified, and representation 3800 encoded appropriately.

Furthermore, it is appreciated that representation 3800 is encoded with a time stamp; in these implementations, when representation 3800 is not acquired at POS terminal and/or payment server 95c within a given time period from the time that representation 3800 was generated, payment will fail and another representation similar to representation 3800 will be generated at device 54c to provide payment. For example, if the given time period is configured to 2 minutes, representation 3800 must be used within 2 minutes of 8 pm, otherwise payment will not occur. These implementations assume that device 54c comprises a clock device. Determination of whether payment is to proceed can occur, for example, via a comparison of a current time with the time encoded in representation 3800. If the difference is greater than the given time period, payment will fail. In some implementations, data representative of the failure can be relayed to device 54c such that a new representation for payment can be generated, initiated either automatically or manually. In other implementations, the consumer using device 54c can be verbally informed of the failure and interact with device 54c to cause a new representation for payment to be generated as described above. Such a safeguard prevents a digital image of representation 3800 from being acquired by a malicious user, storing representation 3800, and later using representation 3800 to pay for items via dynamic content 91c-a encoded in representation 3800.

It is further appreciated that while present implementations have been described with respect to using/publishing a visual artifact to deliver a digital gift card to be stored on a mobile device in a mobile application, any suitable electronic data record and/or dynamic content and/or form of payment is within the scope of present implementation, including but not limited to stored value cards, coupons, offers, tickets, boarding passes, transit passes and the like, and indeed any physical forms that are typically stored in a wallet. Indeed, is appreciated that systems and platforms described herein generate a digital artifact (i.e. any suitable electronic data record and/or dynamic content), then generates a visual artifact that represents the digital artifact. The visual artifact can be published and/or printed in any suitable print media. When scanned using the electronic wallet application, the visual artifact it is then interpreted, and the digital artifact is delivered and stored on a mobile device in a mobile application.

Those skilled in the art will appreciate that in some implementations, the functionality of hardware described herein, including but not limited to devices 54, 54a, 54b, 54c and all servers described herein, can be implemented using pre-programmed hardware or firmware elements (e.g., application specific integrated circuits (ASICs), electrically erasable programmable read-only memories (EEPROMs), etc.), or other related components. In other implementations, the functionality of hardware described herein, including but not limited to devices 54, 54a, 54b, 54c and all servers described herein, can be achieved using a computing apparatus that has access to a code memory (not shown) which stores computer-readable program code for operation of the computing apparatus. The computer-readable program code could be stored on a computer readable storage medium which is fixed, tangible and readable directly by these components, (e.g., removable diskette, CD-ROM, ROM, fixed disk, USB drive). Furthermore, it is appreciated that the computer-readable program can be stored as a computer program product comprising a computer usable medium. Further, a persistent storage device can comprise the computer readable program code. It is yet further appreciated that the computer-readable program code and/or computer usable medium can comprise a non-transitory computer-readable program code and/or non-transitory computer usable medium. Alternatively, the computer-readable program code could be stored remotely but transmittable to these components via a modem or other interface device connected to a network (including, without limitation, the Internet) over a transmission medium. The transmission medium can be either a non-mobile medium (e.g., optical and/or digital and/or analog communications lines) or a mobile medium (e.g., microwave, infrared, free-space optical or other transmission schemes) or a combination thereof.

Persons skilled in the art will appreciate that there are yet more alternative implementations and modifications possible for implementing the implementations, and that the above implementations and examples are only illustrations of one or more implementations. The scope, therefore, is only to be limited by the claims appended hereto.

1. A method comprising;
acquiring at a portable electronic device a visual artifact encoded with content for acquiring an electronic data record associated with dynamic content;
processing said visual artifact to determine said content; and
retrieving said electronic data record from a remote server via a network connection by processing said content at said portable electronic device.

2. The method of claim 1, wherein said visual artifact is further encoded with retrieval content for retrieving an electronic application for processing said electronic data record.

3. The method of claim 2, further comprising:
when said electronic application is currently not installed at said portable electronic device, then:
retrieving said electronic application from a server storing said application; and
installing said electronic application at said portable electronic device prior to said retrieving said electronic data record, and otherwise proceeding with said retrieving said electronic data record.

4. The method of claim 2, wherein said retrieval content comprises a URL for a web install page associated with said electronic application.

5. The method of claim 2, wherein data encoded in said visual content comprises: an envelope portion comprising said retrieval content; and a content portion comprising said content.

6. The method of claim 1, wherein said processing said visual artifact to determine said content comprises decoding said visual artifact.

7. The method of claim 1, wherein said content comprises instructions for said retrieving said electronic data record from said remote server via a web service call.

8. The method of claim 1, wherein said web service call comprises a private web service call to securely retrieve said electronic data record.

9. The method of claim 1, wherein said electronic data record comprises at least one of a business card, a vanity card, a gift card, a stored value card, a loyalty card, an identification card, a retail coupon, a manufacturers coupon, an event badge, a receipt, an event ticket, a subscriber pass.

10. The method of claim 1, wherein said retrieving said electronic data record from said remote server comprises:
retrieving a plurality of indications respectively representative of a plurality of available electronic data records available for download;
receiving input indicative of a choice of one of said plurality of available electronic data records, wherein said choice is indicative of said electronic data record; and
requesting said electronic data record.

11. The method of claim 1, further comprising receiving an indication of dynamic content associated with said electronic data record and rendering a representation of at least one of said electronic data record and said dynamic content.

12. The method of claim 1, wherein said dynamic content comprises a form of payment or electronic rewards, said method further comprising: receiving validation data for validating said electronic data record such that said form of payment or electronic rewards can be transferred to a payment or electronic rewards server.

13. The method of claim 12, wherein said validation data is received from at least one of:
an input device at said portable electronic device; and,
a validation server.

14. The method of claim 1, further comprising:
receiving input indicative that said electronic data record is to be used; in response,
rendering a representation of said dynamic content associated with said electronic data record at a display device of said portable electronic device, such that said dynamic content can be acquired and processed at one or more of a point-of-sale terminal and a payment or electronic rewards server.

15. The method of claim 14, wherein said representation further comprises an expiry code indicative of when said representation expires.

16. The method of claim 14, further comprising:
receiving an indication that said dynamic content have been processed by one more of said point-of-sale terminal and said payment or electronic rewards server; and, in response,
removing said dynamic content from said portable electronic device

17. A portable electronic device comprising:
an input device configured to acquire a visual artifact encoded with content, the content for acquiring an electronic data record associated with dynamic content; and
a processor configured to process said visual artifact to determine said content, the processor further configured to retrieve said electronic data record from a remote server via a network connection by processing said content at said portable electronic device.

18. (canceled)

19. A computer program product, comprising a non-transitory computer usable medium having a computer readable program code, the computer readable program code configured to direct a processor to:
acquire a visual artifact encoded with content for acquiring an electronic data record associated with dynamic content;
process said visual artifact to determine said content; and
retrieve said electronic data record from a remote server via a network connection by processing said content at said portable electronic device.
